(19) United States
(12) Patent Application Publication
(10) Pub. No.: US 2026/0340603 A1
(43) Pub. Date: Oct. 29, 2026

(54) COMPUTING SYSTEM, METHOD, AND APPARATUS FOR AGENTIC WALLET, TOKEN ISSUER, AND PAYMENT PROCESSOR FOR SECURE AGENTIC TRANSACTION PROCESSING WITH SCALABLE TRUST TRANSACTION NETWORK

(71) Applicant: Login ID Inc., San Mateo, CA (US)

(72) Inventors: Simon LAW, San Mateo, CA (US); Teng WU, Waterloo (CA); Francesco MADURI, Toronto (CA); Peter Thien DUONG, Mississauga (CA); Yuriy ACKERMANN, Tauranga (NZ)

(73) Assignee: Login ID Inc., San Mateo, CA (US)

(21) Appl. No.: 19/663,176

(22) Filed: Apr. 29, 2026

Related U.S. Application Data
(60) Provisional application No. 63/797,047, filed on Apr. 29, 2025.
(60) Provisional application No. 63/906,020, filed on Oct. 27, 2025.
(60) Provisional application No. 63/954,010, filed on Jan. 5, 2026.

(51) Int. Cl. G06Q 20/06; G06F 21/62; G06Q 20/36; G06Q 20/40

(52) U.S. Cl. CPC G06Q 20/065; G06F 21/6245; G06Q 20/36; G06Q 20/4016; G06Q 20/405; G06Q 2220/00

(57) ABSTRACT

A computing system is provided for managing transactions initiated by an agentic artificial intelligence (AI) agent on behalf of a user, providing an improvement of an agentic commerce protocol (ACP) or universal commerce protocol (UCP) by reducing consent fatigue while maintaining security and policy enforcement. The system includes an authorization module configured to generate, based on user consent, a signed authorization object that cryptographically binds a verified identity of the agent to a user identity. An authorization control rule engine receives transaction requests from the authorized agent and evaluates each request against a set of authorization rules to determine whether the transaction may be autonomously approved without real-time user confirmation. Responsive to autonomous approval, a token requester module requests a restricted-use payment token from a payment network system, the request including transaction constraints derived from the rule evaluation, enforcing transaction-specific limits and improving secure agent-driven operations with a payment network.

### CROSS-REFERENCE TO RELATED PATENT APPLICATIONS

This patent application claims priority to U.S. Provisional Patent Application No. 63/797,047, filed on Apr. 29, 2025, and titled “SYSTEM, METHOD, AND APPARATUS FOR OPERATOR-CONTROLLED AUTHENTICATION OF LARGE LANGUAGE MODEL-BASED ARTIFICIAL INTELLIGENCE AGENT UTILIZING A DELEGATED USER MANAGED IDENTITY WALLET”,

U.S. Provisional Patent Application No. 63/906,020, filed on Oct. 27, 2025, and titled “SYSTEM, METHOD AND APPARATUS FOR OPERATOR-CONTROLLED AUTHENTICATION OF LLM-BASE AI AGENTS UTILIZING A DELEGATED USER MANAGED IDENTITY WALLET”, and

U.S. Provisional Patent Application No. 63/954,010, filed on Jan. 5, 2026, and titled “FULFILLMENT: AUTONOMOUS ARTIFICIAL INTELLIGENCE AGENT COMPATIBLE WITH HUMAN USER INTERFACE”, the entire contents of which are herein incorporated by reference.

### TECHNICAL FIELD

The disclosed exemplary embodiments relate to computer-implemented systems and methods for providing an agentic wallet, a token issuer, and a payment processor for secure agentic transaction processing. In some cases, the processing is performed in a scalable trust transaction network.

### BACKGROUND

Agentic artificial intelligence (AI) is attracting increasing attention. Intelligent agents can assist humans in completing everyday tasks such as grocery shopping, booking tickets, and more. In some cases, two ways in which these agents interact with online services include:
(1) Executing protocols like the Model Context Protocol (MCP), which are specifically designed for agentic AI agent access to services. Note that the technical systems and improvements provided herein are not restricted to MCP. The term “agentic AI agent” is also herein referred to as “agent”. It will work with any protocols that enable agents to talk to the online services, even the protocols are not specifically designed for agents.
(2) Directly operating human-facing interfaces, simulating user behavior. One example of this mode is OpenAI Operator which operates Web interface directly.

Regardless of the approach, agents typically require user intervention when connecting to a new service. For example, an agent must pause and prompt the user to sign in to Amazon, and then pause again for Booking.com. If the service uses short-lived authentication tokens, the sign-in process becomes even more tedious.

In some cases, autonomous software agents are tasked with performing complex operations, such as online shopping, travel booking, and other automated tasks for a user. To execute these tasks, an agent requires access to the user's sensitive information, including personally identifiable information (PII), authentication credentials for various services, and payment credentials. However, granting agents direct access to such sensitive data introduces significant security and privacy risks. An agent may act maliciously or behave unpredictably due to software bugs, potentially leading to data leakage or unintended financial transactions, such as purchasing an item for a value far greater than what the user intended.

An existing approach to mitigate these security problems is to require explicit human approval for every sensitive step the agent takes. While this provides a degree of security, it fundamentally undermines the core purpose of agentic operations in payment networks. This approach introduces significant ‘consent fatigue’ for the user and negates the efficiency and autonomy that agents are designed to provide. Furthermore, a user may not always be available to provide real-time approval, preventing the agent from executing tasks during off-hours or in the background.

Beyond the challenges of agent governance, the underlying infrastructure of traditional digital payment systems presents a significant barrier to the growth of agentic commerce. These systems typically rely on a model where each digital wallet or digital payment card issuer must establish a direct, bilateral trust agreement with each payment processor or acquirer before transactions can occur. While functional in an ecosystem with a limited number of participants, this model is inherently unscalable. In an agentic commerce environment with potentially thousands of different agentic wallets and specialized payment processors, the number of required bilateral agreements would lead to a combinatorial explosion, making the ecosystem unmanageable and stifling innovation.

This lack of scalability is compounded by the siloed nature of trust data. For instance, payment processors routinely perform ‘Know Your Business’ (KYB) verification for merchants to ensure their legitimacy. However, the results of these critical verifications are not shared across the ecosystem. Consequently, a new agentic wallet has no reliable mechanism to determine whether a merchant is trustworthy before providing it with sensitive user PII or payment credentials. This forces the wallet to either take on unacceptable risk or block potentially legitimate transactions, and leaves the agent vulnerable to engaging with phishing or fraudulent websites.

In view of the foregoing, there are clear and unmet technical problems that generate a desire for a comprehensive technical framework that enables secure, scalable, and autonomous agentic operations to interact with payment networks or payment rails.

### SUMMARY

The following summary is intended to introduce the reader to various aspects of the detailed description, but not to define or delimit any invention.

In at least one broad aspect, a system for managing agent-initiated transactions is provided, the system comprising a processor and a memory storing instructions that, when executed by the processor, configure the system to comprise an authorization module configured to, based on a user's consent, authorize a software agent by generating a signed authorization object that cryptographically binds a verified identity of the software agent to a user's identity. The authorization control rule engine is configured to: receive a transaction request from the authorized software agent, the transaction request pertaining to a purchase from a merchant; and evaluate the transaction request against a set of rules to determine whether to autonomously approve the transaction without requiring real-time user confirmation. The system also comprises a token requester module configured to, in response to the authorization control rule engine autonomously approving the transaction, request a restricted-use payment token from a payment network system, wherein the request includes one or more transaction constraints derived from the evaluation by the authorization control rule engine.

In some cases, the authorization control rule engine is configured to evaluate the transaction request by: first, applying a set of learned rules derived from a history of transactions previously approved by the user; and second, in response to determining that no learned rule from the set of learned rules applies, applying a set of pre-set, risk-based rules.

In some cases, the set of pre-set, risk-based rules defines different transaction amount thresholds for autonomous approval based on a determined risk level associated with the merchant.

In some cases, the one or more transaction constraints included in the request for the restricted-use payment token comprise at least one of: a merchant category, a maximum transaction value, and an identifier of the software agent, thereby enabling the payment network system to enforce the constraints during transaction processing.

In some cases, the authorization control rule engine is further configured to: receive a single user approval for a high-level transaction intent, the intent comprising a plurality of planned sub-transactions; and autonomously approve a plurality of individual transaction requests received from the software agent, wherein each individual transaction request corresponds to one of the planned sub-transactions covered by the single user approval.

In some cases, the authorization control rule engine is further configured to: receive a single user approval for a high-level transaction intent, the high-level transaction intent defining constraints for a plurality of related sub-transactions; and for each of the plurality of related sub-transactions, receive a corresponding individual transaction request from the software agent and, in response to validating that the individual transaction request complies with the constraints, generate an agent-approved transaction object that includes a reference to the high-level transaction intent, thereby establishing a verifiable cryptographic linkage between the agent-approved transaction object and the single user approval.

In some cases, the high-level transaction intent is comprised within a user-approved transaction object that is cryptographically authorized by a digital signature from the user; and each agent-approved transaction object is independently and cryptographically authorized by a digital signature from the software agent without requiring an additional digital signature from the user for the respective sub-transaction.

In another broad aspect, a computer-implemented method for managing agent-initiated transactions is provided. The method comprising: authorizing, by a computing system, a software agent by generating, based on a user's consent, a signed authorization object that cryptographically binds a verified identity of the software agent to a user's identity; receiving, by the computing system from the authorized software agent, a transaction request for a purchase; evaluating, by a policy engine of the computing system, the transaction request against a set of policies to determine whether to autonomously approve the transaction without requiring real-time user confirmation; and in response to autonomously approving the transaction, requesting, by the computing system, a restricted-use payment token from a payment network system, wherein the request includes one or more transaction constraints derived from the evaluation.

In some cases, evaluating the transaction request comprises: first, applying a set of learned rules based on a user's transaction approval history; and second, if no learned rule applies, applying a set of pre-set, risk-based rules that define different approval thresholds based on a risk level of a merchant associated with the purchase.

In some cases, the one or more transaction constraints included in the request for the restricted-use payment token comprise an identifier of the software agent, enabling the payment network system to validate that the transaction was initiated by the authorized software agent.

In some cases, the method further comprising: receiving a single user approval for a high-level transaction intent comprising multiple planned sub-transactions; and autonomously approving a plurality of subsequent transaction requests from the software agent, wherein each subsequent transaction request is validated against the high-level transaction intent.

In at least another broad aspect, a system is provided for managing agent-initiated digital transactions within a scalable trust network, the system comprising a central Trust Authority computer system configured to issue cryptographic certificates to a plurality of agentic wallet systems and a plurality of payment service provider (PSP) systems, thereby establishing a unified trust domain. The system also comprises an agentic wallet system of the plurality of agentic wallet systems, the agentic wallet system being configured to: authorize a software agent to act on behalf of a user; receive a transaction request from the authorized software agent; autonomously approve the transaction request based on a set of policies without requiring real-time user confirmation; and in response to the approval, generate an encrypted payment bundle by encrypting payment data using a public key of the Trust Authority. The system also comprises a PSP system of the plurality of PSP systems, the PSP system being configured to: receive the encrypted payment bundle; and cause the decryption of the encrypted payment bundle to obtain the payment data for processing the transaction, thereby enabling a transaction between the agentic wallet system and the PSP system without a pre-established bilateral agreement.

In some cases, the authorization control rule engine of the agentic wallet system is configured to autonomously approve the transaction request by: first, applying a set of learned rules derived from a history of transactions previously approved by the user; and second, in response to determining that no learned rule from the set of learned rules applies, applying a set of pre-set, risk-based rules that define different approval thresholds based on a determined risk level of a merchant associated with the transaction.

In some cases, the agentic wallet system is further configured to, in response to the approval, request a restricted-use payment token from a payment network system, the request including one or more transaction constraints derived from the set of policies, wherein the transaction constraints include at least one of a merchant category, a maximum transaction value, and an identifier of the software agent.

In some cases, the PSP system is configured to cause the decryption of the encrypted payment bundle by transmitting the encrypted payment bundle to the Trust Authority computer system and receiving decrypted payment data from a decryption application programming interface (API) hosted by the Trust Authority computer system.

In some cases, the Trust Authority computer system is further configured to issue a re-encryption key to the PSP system; and the PSP system is configured to cause the decryption of the encrypted payment bundle by: using the re-encryption key to transform the encrypted payment bundle into a re-encrypted payment bundle; and decrypting the re-encrypted payment bundle using a private key of the PSP system.

In some cases, the PSP system is further configured to issue a merchant cryptographic certificate to a merchant system, the merchant cryptographic certificate including a public key of the merchant system; and the agentic wallet system is further configured to generate an encrypted personally identifiable information (PII) bundle by encrypting user PII with the public key of the merchant system, wherein the encrypted PII bundle is configured for transmission to the merchant system via the software agent.

In some cases, the agentic wallet system is further configured to: receive a single user approval for a high-level transaction intent, the intent comprising a plurality of planned sub-transactions; and autonomously approve a plurality of individual transaction requests received from the software agent, wherein each individual transaction request corresponds to one of the planned sub-transactions covered by the single user approval.

In at least another broad aspect, a computer-implemented method is provided for managing agent-initiated digital transactions within a scalable trust network, the method comprising: issuing, by a central Trust Authority computer system, cryptographic certificates to a plurality of agentic wallet systems and a plurality of payment service provider (PSP) systems; authorizing, by an agentic wallet system of the plurality of agentic wallet systems, a software agent to act on behalf of a user; receiving, at the agentic wallet system, a transaction request from the authorized software agent; autonomously approving, by the agentic wallet system, the transaction request based on a set of policies without requiring real-time user confirmation; in response to the approval, generating, by the agentic wallet system, an encrypted payment bundle by encrypting payment data using a public key of the Trust Authority; receiving, at a PSP system of the plurality of PSP systems, the encrypted payment bundle; and causing, by the PSP system, the decryption of the encrypted payment bundle to obtain the payment data for processing the transaction.

In some cases, autonomously approving the transaction request comprises applying a set of pre-set, risk-based rules that define different transaction approval thresholds based on a risk level associated with a merchant, wherein the risk level is determined based on whether the merchant possesses a merchant cryptographic certificate issued by a certified PSP system within the trust network.

In some cases, the method further comprising: in response to the approval, requesting, by the agentic wallet system, a restricted-use payment token from a payment network system, wherein the request includes an identifier of the software agent to enable the payment network system to enforce that the transaction is initiated by the authorized software agent.

In some cases, the method further comprising: issuing, by the PSP system, a merchant cryptographic certificate to a merchant system, the merchant certificate including a public key of the merchant system; and generating, by the agentic wallet system, an encrypted personally identifiable information (PII) bundle by encrypting user PII with the public key of the merchant system for secure transmission to the merchant system.

### Trust Network

In at least another broad aspect, a system for establishing a scalable trust network for digital transactions is provided. The system comprising: a central Trust Authority computer system configured to: issue a first set of cryptographic certificates to a plurality of payment service provider (PSP) systems, thereby certifying the PSP systems as trusted participants in the network; and issue a second set of cryptographic certificates to a plurality of wallet systems, thereby certifying the wallet systems as trusted participants in the network; wherein a wallet system of the plurality of wallet systems is configured to generate an encrypted payment bundle for a transaction by encrypting payment data using a public key associated with the Trust Authority. A PSP system of the plurality of PSP systems is configured to: receive the encrypted payment bundle; and cause the decryption of the encrypted payment bundle to obtain the payment data for processing the transaction, thereby enabling a transaction between a wallet system and a PSP system without a pre-established bilateral trust agreement.

In some cases, The PSP system is configured to cause the decryption of the encrypted payment bundle by: transmitting the encrypted payment bundle to the Trust Authority computer system; and receiving the decrypted payment data from a decryption application programming interface (API) hosted by the Trust Authority computer system.

In some cases, the Trust Authority computer system is further configured to issue a re-encryption key to the PSP system; and the PSP system is configured to cause the decryption of the encrypted payment bundle by: using the re-encryption key to transform the encrypted payment bundle into a re-encrypted payment bundle; and decrypting the re-encrypted payment bundle using a private key of the PSP system.

In some cases, the PSP system is further configured to: perform a verification process for a merchant system; and upon successful verification, issue a merchant cryptographic certificate to the merchant system, the merchant cryptographic certificate including a public key of the merchant system.

In some cases, the wallet system is further configured to: retrieve the public key of the merchant system from the merchant cryptographic certificate; and generate an encrypted personally identifiable information (PII) bundle by encrypting user PII with the public key of the merchant system, wherein the encrypted PII bundle is configured for transmission to the merchant system through an intermediary software agent that is unable to decrypt the PII.

In at least another broad aspect, a computer-implemented method is provided for processing a digital transaction within a scalable trust network. The method comprising: issuing, by a central Trust Authority computer system, a first cryptographic certificate to a payment service provider (PSP) system and a second cryptographic certificate to a wallet system; generating, by the wallet system, an encrypted payment bundle for a transaction by encrypting payment data using a public key of the Trust Authority; receiving, at the PSP system, the encrypted payment bundle from the wallet system via one or more intermediary systems; and causing, by the PSP system, the decryption of the encrypted payment bundle to obtain the payment data for processing the transaction.

In some cases, causing the decryption of the encrypted payment bundle comprises: transmitting, by the PSP system, the encrypted payment bundle to the Trust Authority computer system; and receiving, by the PSP system, the decrypted payment data from a decryption API of the Trust Authority.

In some cases, causing the decryption of the encrypted payment bundle comprises: receiving, at the PSP system, a re-encryption key from the Trust Authority computer system; using, by the PSP system, the re-encryption key to transform the encrypted payment bundle into a re-encrypted payment bundle; and decrypting, by the PSP system, the re-encrypted payment bundle using a private key of the PSP system.

In some cases, the method further comprising: issuing, by the PSP system, a merchant cryptographic certificate to a merchant system, the merchant certificate including a public key of the merchant system; retrieving, by the wallet system, the public key of the merchant system; and generating, by the wallet system, an encrypted personally identifiable information (PII) bundle by encrypting user PII with the public key of the merchant system.

### Controlling AI Wallet

In at least another broad aspect, a system is provided for controlling an artificial intelligence (AI) wallet, the system comprising: a memory, a network interface, and a processor, the processor operably coupled to the memory and the network interface; and a large language model (LLM) agent and the AI wallet stored in the memory. The processor configured to: send a requested action, using the LLM agent, to the identity wallet; transmit a credential request, using the identity wallet, and receive, using the identity wallet, a credential; and using the LLM agent and the identity wallet to provide the credential to a browser at a certain web address, the web address associated with the requested action.

In some cases, the system is configured to transmit the credential request to a wallet application on a mobile device and to receive the credential from a wallet backend server that is in communication with the wallet application.

In some cases, the AI wallet comprises a tool, a wallet core, and a web extension.

In some cases, the system further comprises a tool interface that communicates between the LLM agent and the tool.

In some cases, the wallet core communicates with the tool and the web extension, and the web extension communicates with the browser.

### Agentic Identity Gateway

In at least a broad aspect, a system is provided for authenticating a software agent in an agentic commerce environment. The system comprises: an Identity Gateway computer system having a processor and a memory. The Identity Gateway is configured to: receive an authentication request from a software agent acting on behalf of a user to access a merchant service; verify an identity of the software agent and a user authorization that grants the software agent permission to act on behalf of the user; and, in response to successful verification, generate and transmit a unified identity token to the merchant service to grant the software agent access. The unified identity token comprises data that cryptographically binds: (i) an identity of the user, (ii) the identity of the software agent, and (iii) a representation of the user authorization.

In some cases, the Identity Gateway is further configured to: generate a global user identifier (GUID) corresponding to a real-world identity of the user; and generate a merchant-specific user identifier (MSUID) by applying a merchant-specific mask to the GUID, wherein the merchant-specific mask is unique to the merchant service; wherein the identity of the user included in the unified identity token comprises the MSUID, thereby preventing the merchant service from tracking the user's activity across different merchant services.

In some cases, the Identity Gateway is further configured to: receive feedback from the merchant service, the feedback pertaining to the software agent and being associated with the MSUID; identify the GUID corresponding to the received MSUID; and update a reputation score associated with the GUID based on the received feedback, thereby enabling ecosystem-wide reputation management while preserving user privacy.

In some cases, the system further comprising a credential manager configured to: provision a first cryptographic credential for the user and a second, distinct cryptographic credential for the software agent; receive a request to sign a transaction initiated by the software agent; determine, based on a set of policies, whether the transaction requires explicit human approval; in response to determining that explicit human approval is required, cause the transaction to be signed using the first cryptographic credential; and in response to determining that the transaction is auto-authorized, cause the transaction to be signed using the second cryptographic credential.

In some cases, the first cryptographic credential is a user passkey and the second cryptographic credential is an agent passkey, and wherein attestation data from the respective passkeys provides verifiable proof of whether the transaction was authorized by the user or autonomously by the software agent.

In at least another broad aspect, a computer-implemented method is provided for authenticating a software agent, the method comprising: receiving, at an Identity Gateway computer system, an authentication request from a software agent acting on behalf of a user for a merchant service; verifying, by the Identity Gateway, an identity of the software agent and a user authorization granting permission for the agent to act on behalf of the user; and in response to successful verification, generating, by the Identity Gateway, a unified identity token that comprises data binding: (i) an identity of the user, (ii) the identity of the software agent, and (iii) a representation of the user authorization; and transmitting the unified identity token to the merchant service to grant the software agent access.

In some cases, the method further comprises: generating, by the Identity Gateway, a global user identifier (GUID) for the user based on a verification of the user's real-world identity; generating, by the Identity Gateway, a merchant-specific user identifier (MSUID) by applying a merchant-specific mask, unique to the merchant service, to the GUID; and including the MSUID as the identity of the user within the unified identity token.

In some cases, the method further comprises: provisioning a user passkey for the user and a distinct agent passkey for the software agent; receiving a transaction signing request initiated by the software agent; determining whether the transaction requires human approval or is auto-authorized by a policy engine; if human approval is required, signing the transaction using the user passkey; and if the transaction is auto-authorized, signing the transaction using the agent passkey, wherein the use of the user passkey versus the agent passkey provides a verifiable record of the transaction's authorization path.

### Agent AI Agent Operations-Fulfillment

In at least a broad aspect, a computing system is provided comprising: an agentic artificial intelligence (AI) agent; an orchestration module in communication with the agentic AI agent; a large language model (LLM) in communication with the orchestration module. The orchestration module configured to: transmit to the LLM a prompt that includes data about a third party computing platform, obtain from the LLM a response that specifies a selected communication option selected from amongst an application programming interface, an agentic protocol, and a web browser and/or app operator, establish an operational communication interface according to the selected communication option with the third party computing platform, instruct the agentic AI agent to communicate via the operational communication interface; and the agentic AI agent interacts with the third-party platform via the operational communication interface.

In at least another broad aspect, a computing system is provided for unified agentic fulfillment, the system comprising: an agentic artificial intelligence (AI) agent; and an orchestration module in communication with the agentic AI agent, the orchestration module configured to: determine an available communication interface for a third-party merchant computing system, the communication interface being selected from a hierarchy of interface types; wherein the hierarchy of interface types comprises, in order of preference, (i) an application programming interface (API), (ii) an agentic protocol, and (iii) a web browser and/or app operator for interacting with a graphical user interface; and instruct the agentic AI agent to interact with the third-party merchant computing system using the determined communication interface.

In some cases, the web browser and/or app operator is configured to operate in a hierarchical fallback mode, further configured to: first, attempt to perform an interaction with the graphical user interface using a Document Object Model (DOM) parsing method; in response to a failure of the DOM parsing method, second, attempt to perform the interaction using a trained machine learning model; and in response to a failure of the trained machine learning model, third, attempt to perform the interaction using a vision-language model (VLM) that visually interprets the graphical user interface.

In some cases, the orchestration module is further configured to, when the web browser and/or app operator is used: instruct the agentic AI agent to transmit cryptographic data to the merchant computing system by programmatically inserting the cryptographic data into a hidden field within source code of the graphical user interface, wherein the hidden field is not rendered for display to a human user.

In at least another broad aspect, a computer-implemented method for providing a verifiable proof of human authorization for a software agent, the method comprising: generating an authorization binding by signing a public key of the software agent with a private key of a user, wherein the private key of the user is protected by a biometric authentication mechanism on a user device; receiving, at the software agent from a third-party verifier, a challenge; generating, by the software agent, a challenge signature by signing the challenge with a private key of the software agent; and transmitting, from the software agent to the third-party verifier, a proof package comprising: the challenge signature, the public key of the software agent, and the authorization binding, thereby enabling the third-party verifier to confirm that the software agent was authorized by the user.

In some cases, the authorization binding further comprises an attestation from the user device proving that the private key of the user is hardware-backed and requires biometric verification for each use.

In at least another broad aspect, a computer-implemented method is provided for enabling a software agent to interact with a merchant computing system, the method comprising: determining, by an orchestration module, an optimal communication interface for the merchant computing system by selecting from a hierarchy of interface types, the hierarchy comprising, in order of preference: (i) an application programming interface (API), (ii) an agentic protocol, and (iii) a browser operator that interacts with a graphical user interface; instructing, by the orchestration module, the software agent to use the optimal communication interface; and in an instance where the browser operator is selected, transmitting cryptographic data from the software agent to the merchant computing system by programmatically inserting the cryptographic data into a hidden field within source code of the graphical user interface, wherein the hidden field is not rendered for display to a human user.

According to some aspects, the present disclosure provides a non-transitory computer-readable medium storing computer-executable instructions. The computer-executable instructions, when executed, configure a processor to perform any of the methods described herein. For example, a non-transitory computer readable medium is provided storing computer executable instructions which, when executed by at least one computer processor, cause the at least one computer processor to carry out one or more methods for machine learning as described herein.

### BRIEF DESCRIPTION OF THE DRAWINGS

The drawings included herewith are for illustrating various examples of articles, methods, and systems of the present specification and are not intended to limit the scope of what is taught in any way. In the drawing are the following figures.

FIG. 1 is a block diagram illustrating an exemplary architecture of a scalable payment trust network, in accordance with an embodiment.

FIG. 2 is a sequence diagram illustrating a process for securely processing a transaction using a decryption API model within the trust network, in accordance with an embodiment.

FIG. 3 is a sequence diagram illustrating a process for securely processing a transaction using a proxy re-encryption model within the trust network, in accordance with an embodiment.

FIG. 4 is a sequence diagram illustrating a process for certifying a merchant within the trust network, in accordance with an embodiment.

FIG. 5 is a block diagram illustrating the structure of an exemplary merchant certificate, in accordance with an embodiment.

FIG. 6 is a block diagram illustrating an exemplary architecture of an agentic digital wallet system, in accordance with an embodiment.

FIG. 7 is a sequence diagram illustrating a process for securely authorizing a software agent with an agentic wallet, in accordance with an embodiment.

FIG. 8 is a block diagram illustrating the structure of an exemplary signed authorization object, in accordance with an embodiment.

FIG. 9 is a flowchart illustrating a two-tier policy evaluation process for autonomously approving transactions, in accordance with an embodiment.

FIG. 10 is a flowchart illustrating a risk-based decision tree for determining a merchant's risk level, in accordance with an embodiment.

FIG. 11 is a block diagram illustrating the structure of an exemplary restricted-use agentic token, in accordance with an embodiment.

FIG. 12A is a block diagram illustrating an exemplary aggregated transaction intent approval, in accordance with an embodiment.

FIG. 12B is a block diagram illustrating a user-approved transaction that includes a plurality of agent authorized sub-transactions, in accordance with an embodiment.

FIG. 13 is a block diagram illustrating another embodiment of the system architecture.

FIG. 14 is a block diagram illustrating an embodiment of the system operating in a pure browser mode.

FIG. 15 is a block diagram illustrating an embodiment of the system operating in a tool mode with web authorization.

FIG. 16 is a block diagram illustrating an embodiment of the system operating in a tool mode for a machine-to-machine communication protocol.

FIG. 17 is a block diagram illustrating a connection between an agent computer and a human mobile device via Bluetooth.

FIG. 18 is a block diagram illustrating a connection between an agent computer and a human mobile device via a wallet backend server using a QR code.

FIG. 19 is a block diagram illustrating a connection between an agent computer and a human mobile device via a wallet backend server using a connection code.

FIG. 20 is a sequence diagram illustrating a screenshot-based operation flow.

FIG. 21 is a block diagram illustrating a hierarchical keystore architecture.

FIG. 22 is a sequence diagram illustrating a browser-based agent login flow.

FIG. 23 is a sequence diagram illustrating a machine-to-machine protocol-based agent login flow.

FIG. 24 is a sequence diagram illustrating a machine-to-machine protocol-based agent authorization flow.

FIG. 25 is a sequence diagram illustrating a process for filling a web payment form.

FIG. 26 is a block diagram illustrating an overall architecture of an agentic identity gateway system, showing how the gateway mediates access between an agent and a web server.

FIG. 27 is a sequence diagram illustrating a process for an agent sign-in using the agentic identity gateway, including redirection, authentication, and ID token issuance.

FIG. 28 is a sequence diagram illustrating a workflow for an auto-authorized transaction, wherein a transaction is signed using an agent passkey without real-time user interaction.

FIG. 29 is a sequence diagram illustrating a workflow for a human-authorized transaction, wherein a user is prompted to approve a transaction before it is signed using a user passkey.

FIG. 30 is a block diagram illustrating the different operational communication interfaces available to an agentic AI agent, including an API client, agentic protocols, and a browser operator.

FIG. 31 is a block diagram illustrating a system architecture for the orchestration and planning of agent operations, showing how the agent selects an appropriate communication interface.

FIG. 32 is a flowchart illustrating a hierarchical process for selecting an operational communication interface for an agent to interact with a merchant.

FIG. 33 is a flowchart illustrating a process for agentic protocol discovery, wherein an agent attempts to identify a supported communication protocol for a merchant.

FIG. 34 is a schematic diagram illustrating the concept of a ring signature, which can be used to provide a privacy-preserving proof of authorization from a member of a group.

### DETAILED DESCRIPTION

In some cases, a computing system is provided that address the technical challenges of securely managing agent actions at the application level. In some cases, the computing system simultaneously establishes a scalable trust architecture at the network level. In some cases, agents operate with a high degree of autonomy without direct access to sensitive user data, enforce user-defined constraints throughout the transaction lifecycle, and enable secure interactions between a digital wallet and any processor in the ecosystem without requiring direct, pre-established agreements.

In some cases, a computing system and a computing method are provided for enabling secure, scalable, and autonomous agentic operations to interact with merchant servers and payment networks. The system establishes a comprehensive trust network that allows heterogeneous participants, such as agentic wallets, payment service providers (PSPs), and merchants, to interact securely without requiring pre-established bilateral agreements. Within this network, an agentic wallet acts as an intelligent user proxy, governing agent actions through risk-based policies and ensuring user intent is maintained throughout a transaction's lifecycle.

### Scalable Payment Trust Network

In existing digital payment systems, each issuer or wallet and each acquirer or payment processor must establish a bilateral agreement to create mutual trust before transactions can occur. This trust relationship ensures that the PSP and acquirer recognize and accept the payment token issued by the issuer. The token is securely stored in the wallet, and both the wallet and PSP must maintain mutual trust and an encrypted communication channel to transmit the token.

This model functions efficiently when the number of wallets and processors is limited. However, in the emerging era of agentic commerce, the ecosystem will expand significantly.

Agents and card issuers may develop their own wallets, while numerous small and medium-sized payment processors will enter the market. Establishing individual agreements among thousands (or millions) of wallets and processors leads to a combinatorial explosion and is inherently unscalable.

Beyond issuers and acquirers, merchants also face growing trust challenges in the agentic era. A major user concern is that agents may fail to distinguish legitimate merchant websites from phishing sites. Although agent developers can employ detection models or maintain blacklists of known phishing domains, such methods are inherently incomplete and probabilistic, as new or sophisticated malicious sites may evade detection.

To address these scalability and trust issues, a scalable payment trust network is provided. It includes a trust network and a trust authority that establish verifiable trust relationships among issuers or wallets, acquirers or payment processors, and merchants. Within the same trust network, any wallet and processor can transact without a direct bilateral agreement. Two architectural models are provided. In a Centralized Validation Model, the trust authority participates in each transaction to validate and coordinate the process. In the second model, which is a Distributed Validation Model, transactions occur directly between wallets and PSPs without real-time trust authority involvement, relying instead on pre-established trust and cryptographic verification mechanisms. Meanwhile, the network leverages the existing Know Your Business (KYB) process imposed by acquirers and payment processors to authenticate merchant websites and issue cryptographic merchant certificates. In some cases, during agentic commerce transactions, these certificates enable the secure transmission of sensitive information—such as personally identifiable information (PII)—to verified merchants, without exposing such data to the agent.

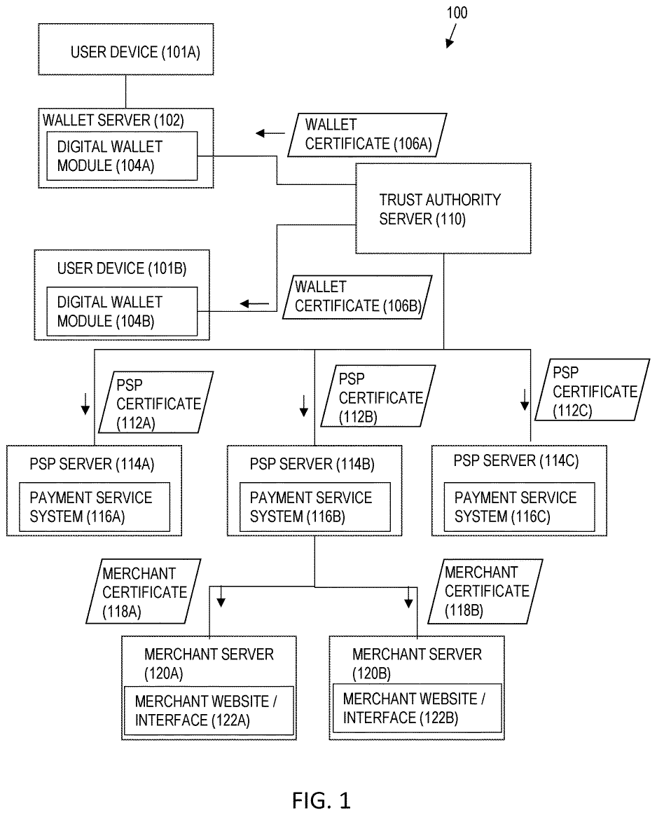

Referring now to the figures, FIG. 1 illustrates an exemplary architecture of a scalable payment trust network system 100. The system 100 is built upon a unified trust domain established by a central Trust Authority computer system, referred to as Trust Authority Server 110. The Trust Authority Server 110 is configured to verify and issue cryptographic certificates to the other primary participants in the network. Specifically, Trust Authority Server 110 issues a first set of cryptographic certificates, such as Wallet Certificates 106A and 106B, to a plurality of agentic wallet systems. In this embodiment, the agentic wallet systems may be implemented as a Wallet Server 102 hosting a Digital Wallet Module 104A on behalf of a User Device 101A, or as a Digital Wallet Module 104B running directly on a User Device 101B.

The Trust Authority Server 110 also issues a second set of cryptographic certificates, such as PSP Certificates 112A, 112B, and 112C, to a plurality of Payment Service Provider (PSP) systems. These PSP systems are represented by PSP Servers 114A, 114B, and 114C, which may operate respective Payment Service Systems 116A, 116B, and 116C.

This certification process establishes all wallet systems and PSP systems as trusted participants. Because all certificates are issued by or traceable to the central Trust Authority Server 110, any participant can cryptographically verify any other participant, thereby eliminating the need for direct, bilateral trust agreements between each wallet and each PSP.

In a further aspect of the architecture, the certified PSP Servers, such as 114A, are configured to perform their own verification (e.g., Know Your Business (KYB)) of merchant systems. Upon successful verification of Merchant Servers 120A and 120B, which host Merchant Website/Interfaces 122A and 122B respectively, the PSP Server 114A issues Merchant Certificates 118A and 118B. This federated model of certification allows trust to be extended to merchants in a scalable manner.

In some cases, the Trust Authority Server establishes and maintains verifiable trust relationships (e.g., via data relationships) among participating entities. In some cases, it functions as the root of trust for the entire ecosystem. In some cases, the Trust Authority Server certifies wallets and PSPs through a standardized verification process. After an entity is successfully certified, the Trust Authority Server issues a digital trust certificate bound to that entity's identity. In some cases, any participant in the trust network can verify both the authenticity of the certificate and the identity of the certified entity, enabling secure and authenticated communication across the network.

Within this architecture, merchants are certified indirectly through PSPs. Each PSP performs its own KYB verification of the merchant and, after successful validation, issues a merchant certificate. These merchant certificates are cryptographically verifiable by any participant in the trust network, regardless of which PSP issued them.

In some cases, the Trust Authority Server verifies the legal entities behind wallets and PSPs through a KYB process. After successful verification, the authority issues a certificate to the wallet or PSP, formally recognizing the entity as a trusted participant in the network. The term certificate in this context is used in a generic sense. It may be in the form of a standard X.509 digital certificate or any other cryptographically verifiable format. Different formats of the certificate can be used. In some cases, the certificate contains sufficient information to uniquely identify the wallet or PSP within the trust network. Each certificate is cryptographically bound to a secret key that is exclusively controlled by the certified entity. This secret key may be a private key in a traditional public key infrastructure (PKI) system or another type of cryptographic key suitable for secure identity binding. The possession of this key enables the certified entity to prove ownership of its certificate and to establish mutual authentication with other participants in the trust network.

In conventional e-commerce computing systems, the payment token is transmitted from the wallet to the PSP through the merchant. Therefore, an encrypted communication “channel” is usually required to be established between the wallet and the payment processor. Conventionally, this setup is handled directly between wallets and payment processors. Once a wallet and a payment processor sign an agreement, the wallet can generate encrypted bundles specifically for that processor. However, as stated above, there is no direct agreement between the wallet and the PSP. A key technical challenge is how to establish a shared encryption key between the wallet and the PSP. Since the wallet typically sends an encrypted bundle to the merchant, which is then forwarded to the PSP, the wallet often does not know the processor's identity when generating the encrypted bundle if there is no 1-1 agreement between wallet and PSP. Consequently, it cannot choose the appropriate key for encryption.

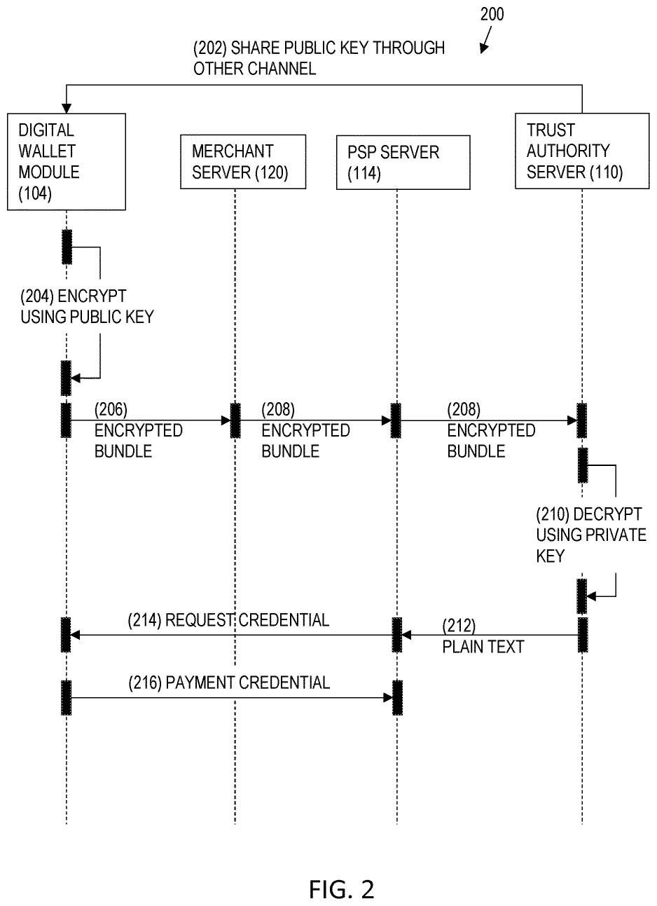

In some cases, a decryption API model is provided to address this problem, as shown in FIG. 2.

FIG. 2 illustrates a process 200 for securely processing a transaction using a decryption API model. The process involves a Digital Wallet Module 104, a Merchant Server 120, a PSP Server 114, and the Trust Authority Server 110. In this model, the Trust Authority Server 110 shares its public key through an appropriate channel at step 202. To initiate a transaction, the Digital Wallet Module 104 generates an Encrypted Bundle 206 by encrypting payment data using the public key of the Trust Authority Server 110 at step 204. The Encrypted Bundle is transmitted via one or more intermediaries, such as the Merchant Server 120, to the PSP Server 114 at steps 206 and 208.

Because the PSP Server 114 does not have the corresponding private key, it cannot decrypt the bundle directly. Instead, the PSP Server 114 causes the decryption of the bundle by transmitting the Encrypted Bundle to the Trust Authority Server 110. The Trust Authority Server 110 uses its private key to decrypt the bundle at step 210, obtaining the Plain Text payment data. The Trust Authority Server 110 then securely provides the Plain Text payment data to the PSP Server at step 212. The PSP Server uses the Plain Text payment data to request credentials from the Digital Wallet Module 104 at step 214. In response to the request, the Digital Wallet Module 104 transmits the payment credential to the PSP Server 114 at step 216, allowing the PSP Server to process the transaction.

In some cases, the wallet does not need to know which payment processor will handle the transaction. When the processor receives the encrypted bundle, it calls the authority's Decryption API to decrypt it. This decryption API model is suitable for the centralized authority who can handle high volume traffic

In some cases, a proxy re-encryption model is provided in alternative to the a decryption API model.

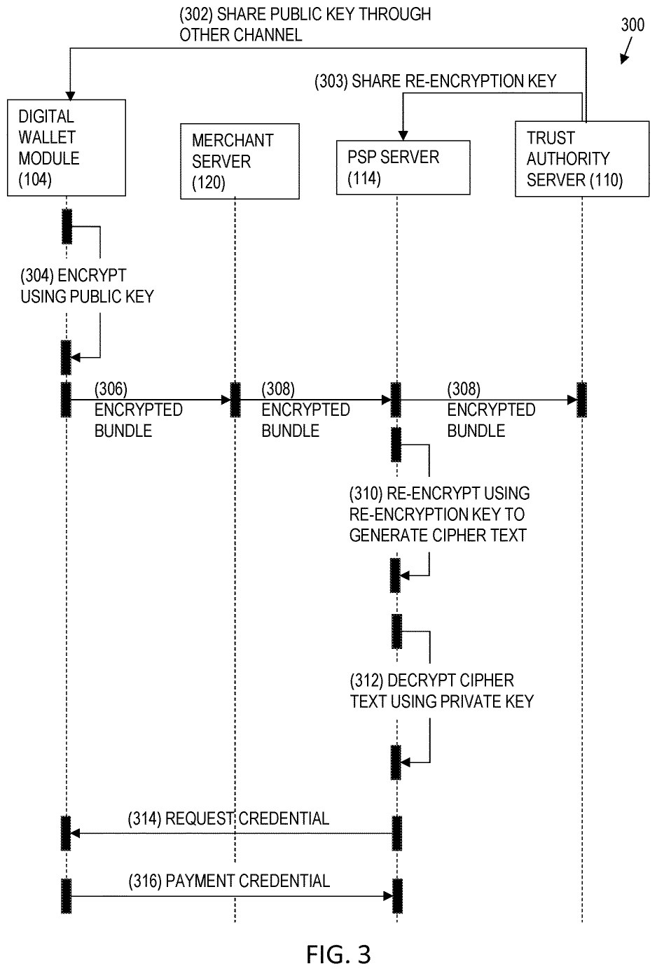

FIG. 3 illustrates an alternative process 300 using a proxy re-encryption model. Here, in addition to the Trust Authority's public key being shared at step 302, the Trust Authority Server 110 also securely shares a unique re-encryption key with the certified PSP Server 114 at step 303. As before, the Digital Wallet Module 104 encrypts the payment data using the Trust Authority's public key to create an Encrypted Bundle 304, which is forwarded to the PSP Server 114 at steps 306 and 308.

In this model, the PSP Server 114 uses the re-encryption key to transform the received encrypted bundle into a new ciphertext at step 310. This re-encrypted bundle is formatted such that it can be decrypted by the PSP Server 114 using its own private key at step 312. After submitting a request for payment credential to the Digital Wallet Module 104 at step 314, the PSP Server 114 can then obtain the payment credential 316. This model is more scalable as it avoids creating a processing bottleneck at the Trust Authority Server 110.

In some cases of the proxy re-encryption model, when a payment processor registers with the Trust Authority Server, the authority issues a re-encryption key that allows ciphertexts encrypted with the Trust Authority Server's public key to be transformed into ciphertexts encrypted under the processor's public key-without revealing the plaintext.

In some cases of the proxy re-encryption model, the wallet still encrypts the bundle with the Trust Authority Server's public key. Instead of asking the Trust Authority Server to decrypt it, the payment processor uses its re-encryption key to convert the ciphertext into one that can be decrypted using its own private key. This model is more scalable compared with the previous model. It doesn't require the Trust Authority Server to be able to ingest and process high volumes of traffic.

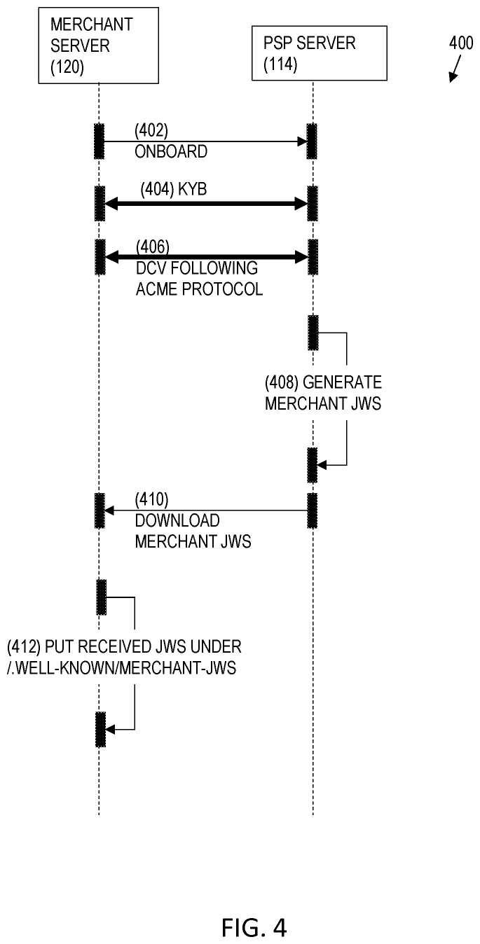

FIG. 4 illustrates a process 400 for a PSP Server 114 to certify a Merchant Server 120. The process begins with the merchant onboarding with the PSP at step 402, followed by a Know Your Business (KYB) verification at step 404. At step 406, a Domain Control Validation (DCV) process, such as the ACME protocol, may be used to verify the merchant's control over its domain. In response to successful verification, the PSP Server 114 generates a merchant certificate (e.g., a JSON Web Signature-JWS) at step 408. The Merchant Server 120 can then download this certificate at step 410 and make it publicly available for verification at step 412.

Usually the merchant is responsible if the transaction has a charge back. Because of the encrypted bundle, the system can pass more information to the PSP Server and the PSP Server can verify the transaction. Since it significantly reduces the risk of transactions, issuers are more willing to take the responsibility. Therefore, the liability is shifted from the merchant to the issuers.

Below are two cases how the PSP Serve can get the extra data to verify the transaction.

### Case 1: Merchants Implement Special Protocols Like Agentic Commerce Protocol (ACP).

Since the merchant implemented special protocols like ACP which allows the merchant to accept special tokens other than just credit card and card verification value (CVV), the merchant server can transmit the encrypted bundle to the PSP server. The PSP server decrypts the bundle according to the bundle encryption type and verifies the transaction.

### Case 2: Merchants Don't Implement Special Protocols Like ACP.

In some cases, the merchant server cannot accept a special encrypted bundle. The system can still generate a 16-digit token and 3-digit DTVV and pass the token to the merchant. After the PSP receives the token from the merchant, the PSP will know it is a liability shifting token issued by a special wallet. This can be done by looking at the token number. Therefore, the PSP will go to the API end point of the wallet and retrieve the extra transaction information to verify the transaction.

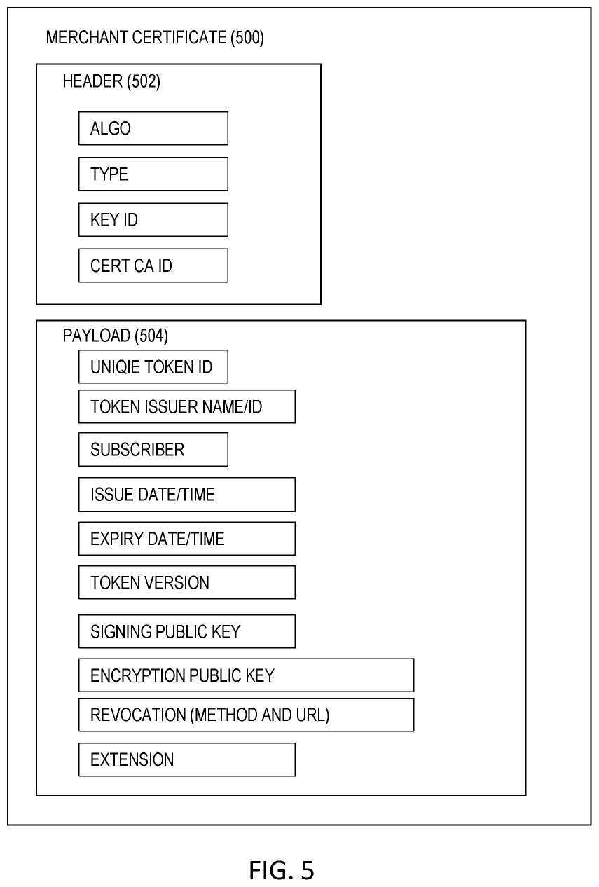

FIG. 5 shows the structure of an exemplary Merchant Certificate 500. The certificate may comprise a Header 502 and a Payload 504. The Header 502 includes information about the cryptographic algorithms used (ALGO), token type (TYPE), key ID (KEY ID), and certificate authority ID (CERT CA ID). The Payload 504 contains the substantive information, including a unique token ID, the issuer's name/ID, the subscriber (merchant ID), issuance and expiry dates/times, token version, and critically, the merchant's signing and encryption public keys. It may also include information for revocation.

In some cases, each PSP Server possess its own X.509 digital certificate and issues a merchant certificate to the verified merchant after the KYB process. The merchant certificate can be a standard X.509 certificate or just simply a JSON token. The following example is an example of a JSON object.

Header

```
{
  “alg”: “EdDSA”,
  “typ”: “JWT”,
  “kid”: “token-issuer-ed25519-key-1”,
  “x5c”: [
    “MIICZTCCAkugAwIBAgIU... (leaf certificate, Base64 DER)”,
    “MIICHTCCAcSgAwIBAgIU... (intermediate CA)”,
    “MIICBTCCAYWgAwIBAgIU... (root CA)”
  ]
}
Payload
  “jti”: “uuid-123456789”,
  “iss”: “token-issuer-name-or-domain”,
  “sub”: “merchant_12345”,
  “iat”: 1730100000,
  “exp”: 1732688000,
  “token_version”: “v1.0.0”,
  “merchant”: {
    “merchant_name”: “Example Store”,
    “merchant_domain”: “example.com”
  },
  “signing_public_key”: {
    “kty”: “OKP”,
    “crv”: “Ed25519”,
    “alg”: “EdDSA”,
    “x”: “base64url_encoded_public_key”
  },
  “encryption_public_key”: {
    “kty”: “OKP”,
    “crv”: “X25519”,
    “alg”: “ECDH-ES+XC20PKW”,
    “x”: “base64url_encoded_public_key”
  },
  “revocation”: {
    “method”: “API”,
    “url”: “https://authority.examplepsp.io/status”
  },
  “extension”: {
    “custom_field”: “some optional value”
  }
}
```

If the information included in the merchant JWS token is considered to be confidential and only authorized agents can get access, the system automatically encrypts the JWS token to turn it into a JWE token. The decryption is controlled by the Trust Authority Server. In some cases, the decryption key cannot be given to the agents.

In some cases, wallets often store users' PII, such as shipping addresses, which are required by merchants to calculate taxes, determine shipping costs, and fulfill orders. In an agentic operations, such as transactions with merchants that interact with a payment network, the agent operates as an intermediary between the wallet and the merchant. However, these PII elements are not necessary for the agent to perform its tasks and therefore must not be exposed to the agent.

In some cases, to ensure confidentiality, PII transmitted from the wallet to the merchant is encrypted end-to-end. In some cases, this system employs a key derivation mechanism based on the public keys embedded in both the merchant's certificate and the wallet's certificate. Using these public keys, the system derives an ephemeral encryption key that is used exclusively for the current transaction.

In some cases, only entities that possess the corresponding private keys—namely, the certified wallet and the certified merchant—can decrypt the PII payload. In some cases, this mechanism ensures that sensitive information is securely transmitted within the trust network, while the intermediary agent remains unable to access or infer any protected user data.

### Agentic Wallet for Secure Transactions

During agentic online shopping computations and interactions with online merchant servers (e.g., online or web-based storefronts), agents typically access personally identifiable information (PII), authentication credentials, and payment credentials. Users are often hesitant to share such sensitive data with agents due to security and privacy risks. Agents may act maliciously or behave unpredictably, leading to potential data leakage. To enable secure agenti c commerce, in some cases it is desirable for a trusted wallet system to manage and provide PII, identity credentials, and payment credentials to agents in a controlled and verifiable manner.

Protection of payment credentials presents additional technical security challenges. Even when credentials are shared with legitimate merchants, unintended transactions may occur—for example, an agent purchasing a $1000 item instead of the intended $100 one. In such cases, the wallet alone cannot guarantee sufficient protection; token issuers and payment processors must participate to provide transaction-level enforcement and control.

In some cases, the security risks described above can be mitigated through human approval at every step of the transaction process. However, this approach introduces significant consent fatigue and undermines the core purpose of agentic technology improvements. Users may not always be present to approve actions; for example, an agent might execute a task during off-hours, such as early in the morning while the user is asleep. The fundamental goal of employing agents is to offload repetitive and time-consuming tasks from humans, not to introduce new approval burdens. Requiring continuous human interaction negates the efficiency and autonomy that agents are designed to provide. This invention enables autonomous agentic shopping that maintains a high level of security and trustworthiness with minimal constant human oversight.

The system described herein provides an agentic wallet and its interactions with token issuers and payment processors. The system provides a secure, verifiable framework for agent authorization and transaction control in agentic commerce. In some cases, methods are provided for securely authorizing agents to access wallets in a cryptographically verifiable manner. In some cases, mechanisms are provided for wallets to evaluate and decide on agent requests involving personally identifiable information (PII), identity credentials, or payment credentials. In some cases, coordinated protocols among wallets, token issuers, and payment processors are provided to enforce wallet decisions and verify user purchase intent. In some cases, to differentiate between operations initiated by humans and those initiated by agents, separate credentials are employed for human and agent transaction approvals. In some cases, optimization techniques are proposed for intelligent payment method selection and aggregated transaction authorization, improving both efficiency and security in agentic operations interacting with merchant servers and a payment network.

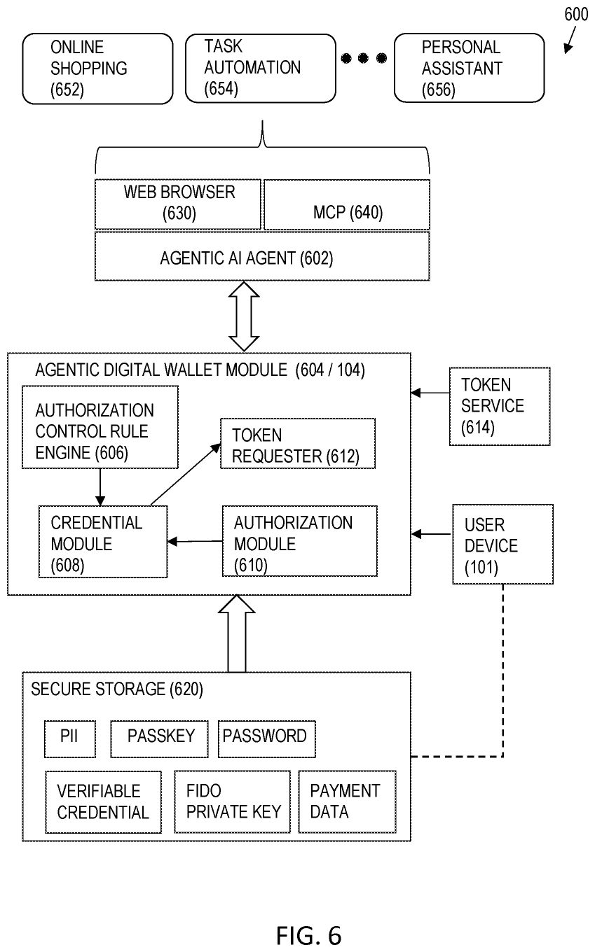

Referring now to FIG. 6, the architecture of an agentic digital wallet system 600 is shown. The system is designed to manage agent actions, which may relate to tasks like Online Shopping 652, Task Automation 654, or serving as a Personal Assistant 656. A software agent, Agentic AI Agent 602, interacts with services via a Web Browser 630 or a machine-to-machine communication protocol (MCP) 640.

The core of the system is the Agentic Digital Wallet Module 604 (which in some cases is interchangeable with the Digital Wallet 104). It comprises several key components. An Authorization Module 610 is configured to securely authorize the Agentic AI Agent 602. A Credential Module 608 manages access to sensitive data stored in Secure Storage 620, which may include PII, Passkeys, Passwords, Verifiable Credentials, Fast Identity Online (FIDO) Private Keys, and Payment Data. An Authorization Control Rule Engine 606 evaluates transaction requests from the agent against a set of control rules to determine whether to approve them autonomously. A Token Requester 612 is configured to request restricted-use payment tokens from a Token Service 614 (e.g., a payment network system) based on an approved transaction. The wallet interacts with the user via a User Device 101.

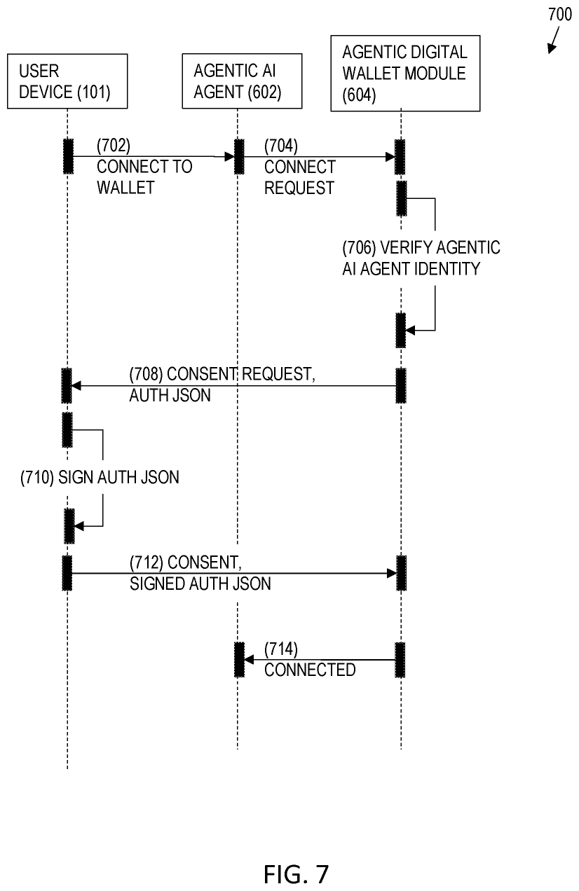

FIG. 7 illustrates the process 700 for authorizing an Agentic AI Agent 602. The agent initiates a connection request to the Agentic Digital Wallet Module 604 at steps 702 and 704. This request includes information that identifies the Agentic AI Agent 602. The wallet module first verifies the agent's identity at step 706. It then presents this verified identity to the user on User Device 101 along with a consent request and an authorization JSON object (auth JSON) at step 708. The user provides consent by digitally signing the auth JSON at step 710. The signed auth JSON is returned to the wallet module at step 712, which completes the authorization and establishes a connection with the agent at step 714.

In some cases, the authenticity of the Agentic AI Agent's identity may be established through various mechanisms. In some cases, a mechanism is to employ Public Key Infrastructure (PKI). In this example, the Agentic AI Agent is associated with a domain name, from which a public key can be obtained. The Agentic AI Agent then signs a HTTP request using the corresponding private key, and the wallet verifies the signature using the public key retrieved from the domain. In some cases, the web based wallet is an example. The same technique of using PKI and message signing can be applied to native wallets as well. In some cases, the authorization process of FIG. 7 takes place only after the identity of the Agentic AI Agent has been verified.

In response to verifying the Agentic AI Agent's identity, the Agentic Digital Wallet Module will be aware of the authenticated identity and can present this verified identity to the user device. During this process, when the backend requests the consent from the user, via their user device, information about the Agentic AI Agent's public key is embedded within the request. Specifically, the Agentic Digital Wallet Module constructs a JSON object (also more generally called an authorization object) as follows and lets the user sign on the hash of the object. Note that this JSON object shown below is just an example. The user identity and the agent identity must be included in the object. In some cases, the Agentic AI Agent's identity must be associated with a cryptography key.

```
{
  user_identity: {
  user_id: $id,
  email: $email,
  phone: $phone,
  address: $address,
},
agent_identity: {
  name: $name,
  domain: $domain,
  manufacturer: $manufacturer,
  public_key_url: $url,
public_key_id: $kid,
  contact_email: $contact_email,
},
signature_algorithm: {
  hash: $hash_algorithm,
  signature: $signature_algorithm,
}
issued_date: $timestamp,
expiry: $time,
nonce: $randomnumber,
}
```

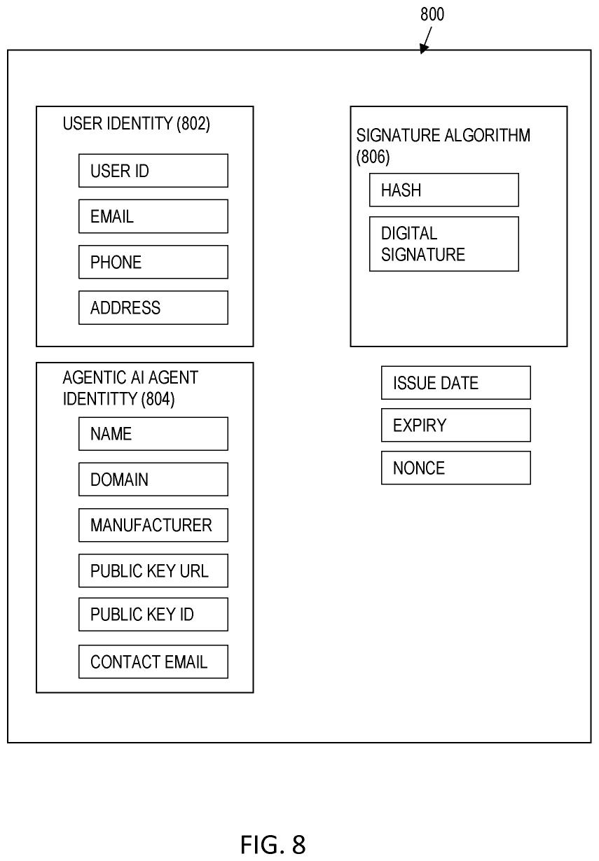

In a more general case, FIG. 8 shows an exemplary authorization object 800. This signed object cryptographically binds the User Identity 802 (containing fields like user ID, email, etc.) to the Agentic AI Agent Identity 804 (containing fields like name, domain, and public key URL). The object also includes details of the Signature Algorithm 806 used, along with issuance and expiry information. This object serves as a verifiable credential proving the agent is authorized to act for the user.

Responsive to receiving a request, after verifying the Agentic AI Agent, the user device generates a digital signatures of the hash of the entire authorization object. In some cases, before the digital signing of the authorization object, the user device automatically attaches the key ID of the passkey which is used to sign, to the authorization object. After successful completion of authorization, the Agentic AI Agent receives an access token. This access token is a long-lived credential that enables the Agentic AI Agent to subsequently access the digital wallet. The access token includes the JSON object (also called the authorization object), the key ID and the signature. In some cases, that the access token serves as a digital certificate of the Agentic AI Agent. In some cases, other computing servers or devices that receive this token can extract the public key using the URL encoded in the JSON object (also called the authorization object).

In this example, the user device signs the authorization object using a passkey. In some other cases, other keys or a Verifiable Credential (VC) is used to digitally sign the authorization object. If using VC, the JSON object will be included in the presentation of the VC.

When the Agentic AI Agent is required to prove the authorization, the Agentic AI Agent presents this signed authorization object and uses the corresponding cryptography key to sign the verifier's challenge. The verifier uses the key included in this authorization object to verify the signed challenge.

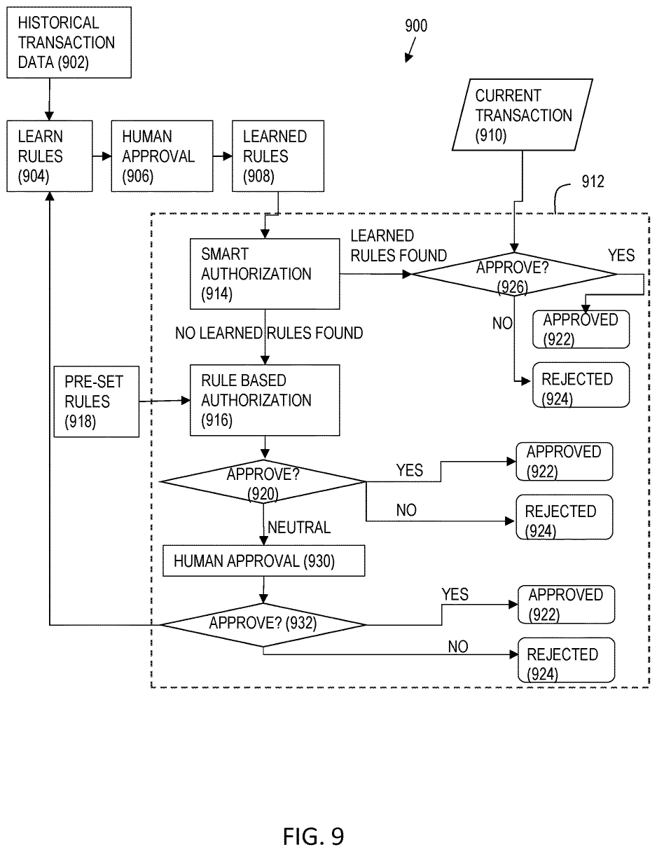

FIG. 9 illustrates the two-tier policy evaluation process 900 performed by the Authorization Control Rule Engine 606. When a Current Transaction 910 is requested by the agent (which refers to the Agentic AI Agent), the authorization flow 912 begins. First, a Smart Authorization module 914 checks if the transaction matches any Learned Rules 908, which are derived from Historical Transaction Data 902 and past Human Approvals 906. If a matching learned rule or rules is/are found, the current transaction is compared against the found rule(s). If the current transaction satisfies an approval condition of the found rule(s) approved at step 926, then the current transaction progresses to an Approved state 922. Otherwise, if the current transaction does not satisfy an approval condition of the found rule(s) approved at step 926, then the current transaction progresses to an Rejected state 924.

If no learned rules are found, the process falls back to a Rule Based Authorization module 916, which applies Pre-Set Rules 918. These rules may result in an immediate approval or rejection based on risk, or classify the transaction as “Neutral.” For a neutral outcome at step 920, the decision is escalated for Human Approval 930. The user's decision at step 932 determines if the transaction is Approved 922 or Rejected 924. This two-tier process balances autonomy and security.

The human approval data is fed back to a Learn Rules module 904. The Learn Rules module 904 uses historical transaction data 902 and/or recent or current human approval or disapproval data to generate new rules, or modify existing rules, or both. In some cases, the Learn Rules module 904 includes a large language model that that includes input prompt templates that automatically reference the historical transaction data 902 and/or recent or current human approval or disapproval data. In some cases, the Learn Rules module 904 outputs the new rules and/or modified existing rules to a digital interface for a human to approve (such is a process 906), before being published and stored in Learned Rules 908. Alternatively, the new rules and/or modified existing rules are automatically published and stored in the Learned Rules 908.

In some cases, pre-set rules are static rules. For example, the agent is only allowed to approve the transaction that is less than $100 and each day it can only approve less than 5 transactions. The problem of the static policy is its flexibility. For some high-risk websites, the agent is prohibited from providing any payment information to them, while for the low risk websites, the allowance is be higher. Below is a risk-based policy which balances the risk and user experience. In some cases, the risk policy can change according to the scenario. The system is configured to automatically execute a risk computation and, in response, automatically select the policy.

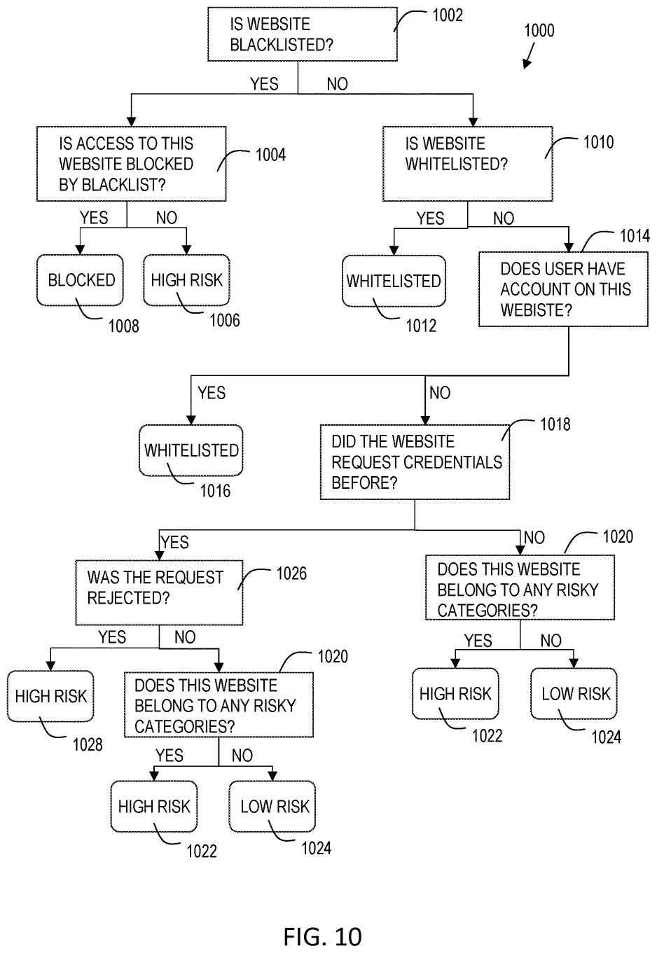

FIG. 10 shows a policy decision tree 1000 for determining a merchant's risk level, which in some cases is an input for the pre-set rules. The process checks if a website is on a blacklist (1002) or a whitelist (1010). A blacklisted site may be Blocked 1008 or deemed High Risk 1006, as per a computing operation 1004. A whitelisted site 1012 is low risk. For other sites, the risk computation includes determining whether the user has an account for the website (1014). If so, the website is whitelisted (1016). If not, then the risk computation process to determine whether credentials were requested before (1018). If not, the risk computation proceeds to determine whether the website belongs to risky categories (1020), and if not, the classifying the website as Low Risk 1024; the website is classified as High Risk 1022 if the website belongs to a risky category. If the website did request credentials before, the risk computation determines if the request was rejected (1026). If so, the website is High Risk (1028). If not, the process of risky categorization (1020, 1022, 1024) is determined. This risk determination informs the approval thresholds in the Authorization Control Rule Engine.

In some cases, the risk computation includes the processing the following table.

| Operation | Website | |
|---|---|---|
| Category | Risk | Confirmation Needed? |
| Financial | High | Any financial operation needs confirmation. |
| operation | Neutral | Single payment more than $50 |
| | | Or |
| | | Subscription |
| | Low | Single payment more than $100 |
| | | Or |
| | | Subscription more than $50 per month |
| | Whitelisted | More than $500 |
| | | Or |
| | | Subscription more than $100 per month |
| Identity | High | Any identity operation needs confirmation. |
| operation | Neutral | Need confirmation if asking for the |
| | | following information. |
| | | Asking for any government issued ID |
| | | numbers or photo copies, such as SIN/SSN, |
| | | passport, driver's license. |
| | | Asking for financial information such as |
| | | bank account number, mortgage monthly |
| | | pay, credit limit. |
| | | Asking for answers apparently for security |
| | | questions such as what is your mother's |
| | | middle name? What was the name of the |
| | | street when you lived as a child? Etc |
| | | Asking for combinations of PII that can be |
| | | accurately linked to a specific individual, |
| | | such as what are your name, birthday and |
| | | address? (note that only address or |
| | | name cannot be accurately linked to a |
| | | specific individual) |
| | Low | Government issued ID |
| | | Or |
| | | Financial information |
| | Whitelisted | No confirmation needed. |

If one website is on the black list, it is either Blocked for being accessed, or financial operation or identity operation or both are forbidden.

After a set of authorization control rules is defined, the agentic wallet is able to verify compliance with the policy before approving a transaction. In some cases, after an agent obtains a payment token, the agentic wallet itself cannot directly control how that token is used. In some cases, the agentic wallet cannot ensure that the token is only applied to purchases consistent with the approved policy, nor can it prevent the token from being used for a transaction of higher value than originally declared by the agent.

To address this limitation, the system provided herein uses agentic tokens issued by entities such as Visa or Mastercard to enforce the policy at the payment network level. Agentic tokens typically support restrictions on both merchant category and transaction amount. In this approach, the policy is translated into a purchase intent, which is transmitted to Visa or Mastercard to obtain an agentic token. When the agent presents this token for payment, the payment network validates the transaction against the original purchase intent to ensure compliance with the policy. If the payment network detects any discrepancy between the transaction parameters and the declared purchase intent, the transaction is declined.

In some cases, the Token Service issues its own agentic token (also herein called a restricted-use Agentic Token). The agentic token will restrict more than Visa's intelligence commerce token. In some cases, because the agentic wallet has the agent identity information as well as the user's authorization, on top of the Visa agentic token, the system can further restrict the agent identity.

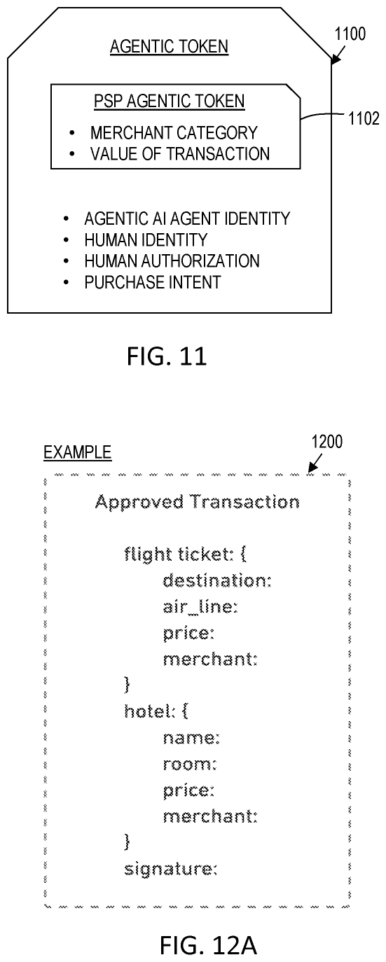

FIG. 11 illustrates the structure of a restricted-use Agentic Token 1100. When the agentic wallet approves a transaction, it requests this token. The token may encapsulate a standard PSP Agentic Token 1102, which includes constraints such as Merchant Category and Value of Transaction. The invention enhances this by also including the Agentic AI Agent Identity, Human Identity, Human Authorization reference, and Purchase Intent. This allows a payment network to perform much more granular enforcement, ensuring not only that the transaction value is correct but also that it was initiated by the authorized agent in accordance with the user's approved intent.

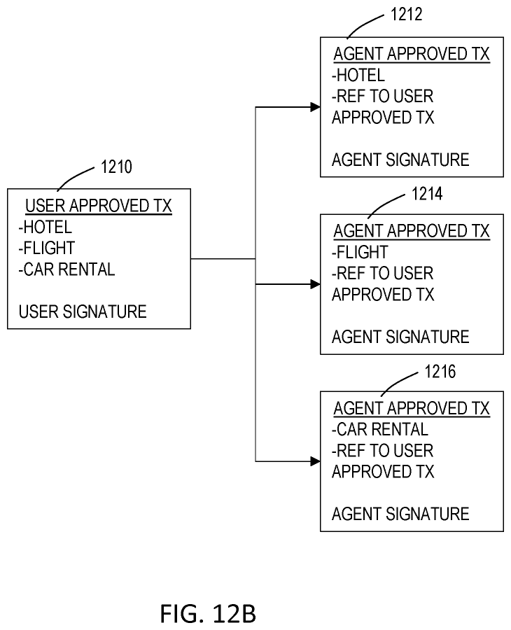

FIG. 12A shows an example of an aggregated transaction intent 1200. In this example, a user authorizes execution of a complex, multi-step task-such as trip planning-via a single cryptographic approval, for example, a single signature.

The aggregated transaction intent 1200 encapsulates multiple sub-transaction intent structures, each corresponding to a respective component of the complex task. In some cases, the sub-transactions may include purchasing a flight ticket, reserving a hotel, and arranging ground transportation. After approved by the user, the aggregated transaction intent 1200 serves as a pre-authorized constraint object. An agentic wallet is configured to receive individual execution requests from an agent for each sub-transaction and to validate each such request against the parameters, permissions, and constraints defined in the aggregated transaction intent 1200. In response to successful validation, the agentic wallet may autonomously approve or sign the requested sub-transaction without requiring additional user interaction.

FIG. 12B shows an example of an aggregated authorization mechanism that enables autonomous approval of multiple related transactions based on a single user-approved transaction intent. A user-approved transaction 1210 includes a plurality of authorized sub-transactions, such as a hotel transaction, a flight transaction, and a car rental transaction. The user-approved transaction 1210 is cryptographically authorized by a user signature and represents a high-level intent encompassing multiple individual transaction types.

Based on the user-approved transaction 1210, an agent (for example, an autonomous software agent or delegated wallet agent) generates a plurality of agent-approved transactions 1212, 1214, and 1216. Each agent-approved transaction corresponds to a respective sub-transaction authorized by the user-approved transaction 1210. In the illustrated embodiment: Agent-approved transaction 1212 corresponds to the hotel sub-transaction, Agent-approved transaction 1214 corresponds to the flight sub-transaction, and Agent-approved transaction 1216 corresponds to the car rental sub-transaction.

In some cases, each agent-approved transaction includes a reference to the user-approved transaction 1210, thereby establishing a cryptographic and logical linkage between the agent-approved transaction and the original user authorization. The agent-approved transactions are independently authorized using an agent signature, without requiring additional user interaction or signatures.

In some cases, prior to signing an agent-approved transaction, the agent or an agentic wallet validates that the requested transaction parameters comply with the scope, constraints, and permissions defined in the user-approved transaction 1210. Such constraints may include, by way of example, transaction type, spending limits, time windows, merchants, destinations, or other policy conditions. Only upon successful validation is the agent-approved transaction cryptographically signed and submitted for execution.

Accordingly, FIG. 12B demonstrates how a single user authorization can be aggregated and securely delegated to enable multiple autonomous transactions, while preserving user control through reference-based validation and constraint enforcement. In some cases, the reference to the user-approved transaction within each agent-approved transaction enables third parties, validators, or settlement systems to verify that the agent-approved transaction is derived from, and constrained by, a valid user authorization, thereby reducing trust requirements placed on the agent.

In some cases, the agentic wallet system is not a standalone entity, and is an intelligent participant operating within the infrastructure established by the scalable payment trust network. This integration begins with the agentic wallet system itself being certified as a trusted entity. A central Trust Authority computer system issues cryptographic certificates to a plurality of agentic wallet systems, including the user's wallet, and to a plurality of payment service provider (PSP) systems. This act of certification, depicted in the overall network architecture of FIG. 1, establishes a unified trust domain where the agentic wallet (e.g., 104B) is a first-class, verifiable participant. This foundational trust is critical, as it ensures that all actions originating from the wallet, including the authorization of a software agent and the initiation of transactions, are cryptographically attributable to a legitimate and known entity within the ecosystem, thereby forming the bedrock of security for all subsequent operations.

In some cases, a system for managing agent-initiated digital transactions within a scalable trust network is provided. The central Trust Authority computer system issues cryptographic certificates to a plurality of agentic wallet systems and a plurality of payment service provider (PSP) systems, thereby establishing a unified trust domain. In some cases, an agentic wallet system of the plurality of agentic wallet systems, executes the following operations: authorizing a software agent to act on behalf of a user; receiving a transaction request from the authorized software agent; autonomously approving the transaction request based on a set of policies without requiring real-time user confirmation; and, in response to the approval, generating an encrypted payment bundle by encrypting payment data using a public key of the Trust Authority. The PSP system of the plurality of PSP systems, executes the following operations: receiving the encrypted payment bundle; and causing the decryption of the encrypted payment bundle to obtain the payment data for processing the transaction, thereby enabling a transaction between the agentic wallet system and the PSP system without a pre-established bilateral agreement.

In some cases, the integration facilitates the wallet's ability to protect user privacy, a feature that complements the secure transaction process. While the software agent acts as an intermediary, it should not have access to sensitive user data like a shipping address. The trust network's federated certification model enables this privacy preservation. The agentic wallet system can retrieve the merchant's public key from its verifiable merchant certificate (500), which is available because the merchant is a participant in the trust network. The wallet then uses this public key to generate an encrypted Personally Identifiable Information (PII) bundle. The software agent can forward this encrypted bundle to the merchant system (120), but it remains unable to access the contents. This ensures end-to-end confidentiality between the user's wallet and the merchant, a critical feature made possible only because the trust network provides a reliable and scalable mechanism for discovering and trusting a merchant's public key.

In some cases, the trust network reinforces the integrity of the very first step in the agentic commerce process: the authorization of the software agent. The agentic wallet system is configured to authorize a software agent to act on behalf of a user. This is accomplished by creating a signed authorization object (800) that cryptographically binds the agent's identity to the user's identity. The trustworthiness of this authorization object in the broader ecosystem is guaranteed by the network. Because the agentic wallet system itself is a certified entity holding a certificate from the Trust Authority (110), its digital signature on the authorization object is verifiable and originates from a trusted source. This allows third parties, such as high-value merchants or other services within the network, to validate and trust that the software agent is operating under a legitimate mandate from a certified wallet, thus securing the entire chain of delegation from user to wallet to agent.

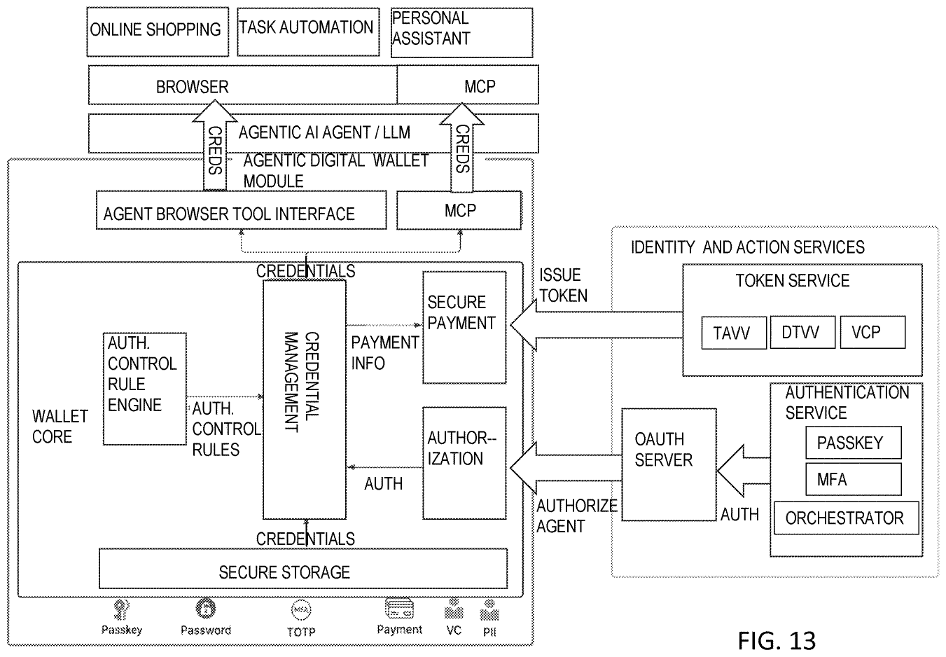

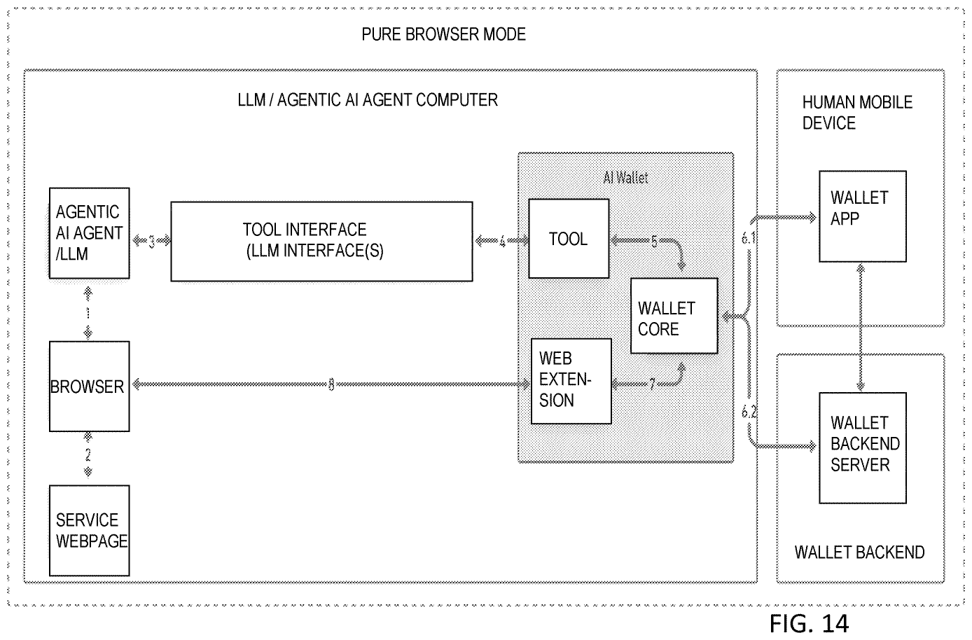

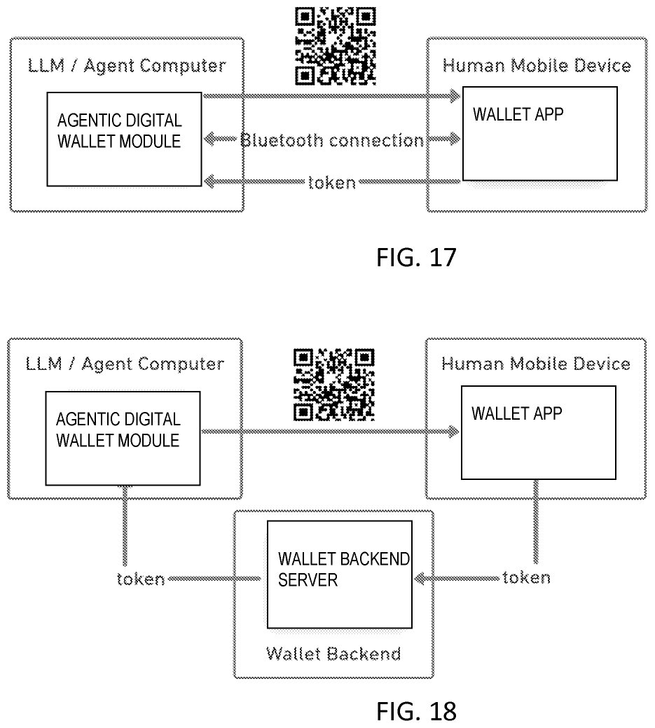

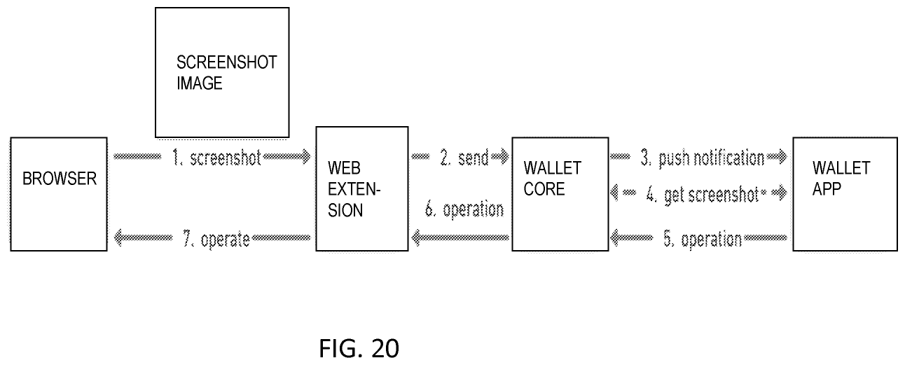

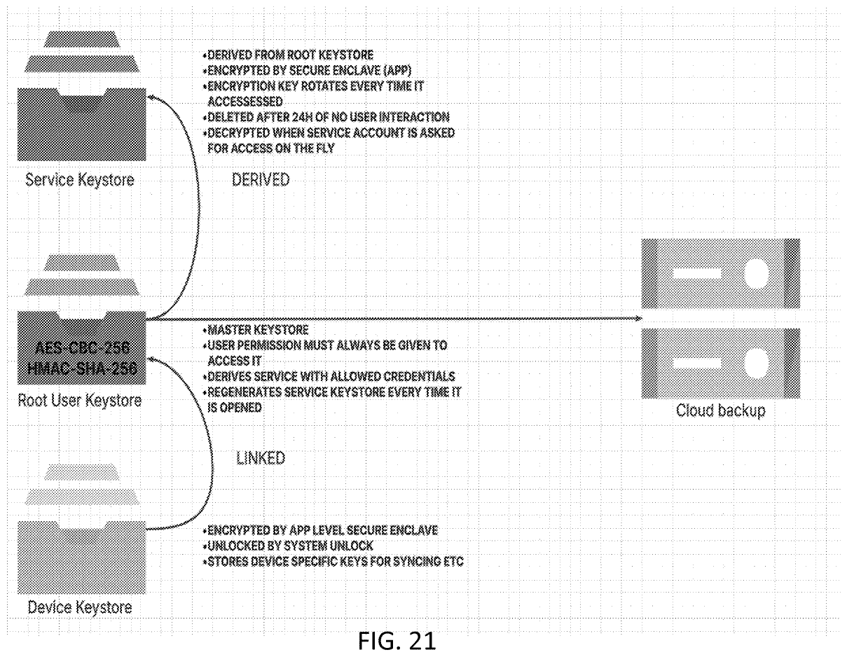

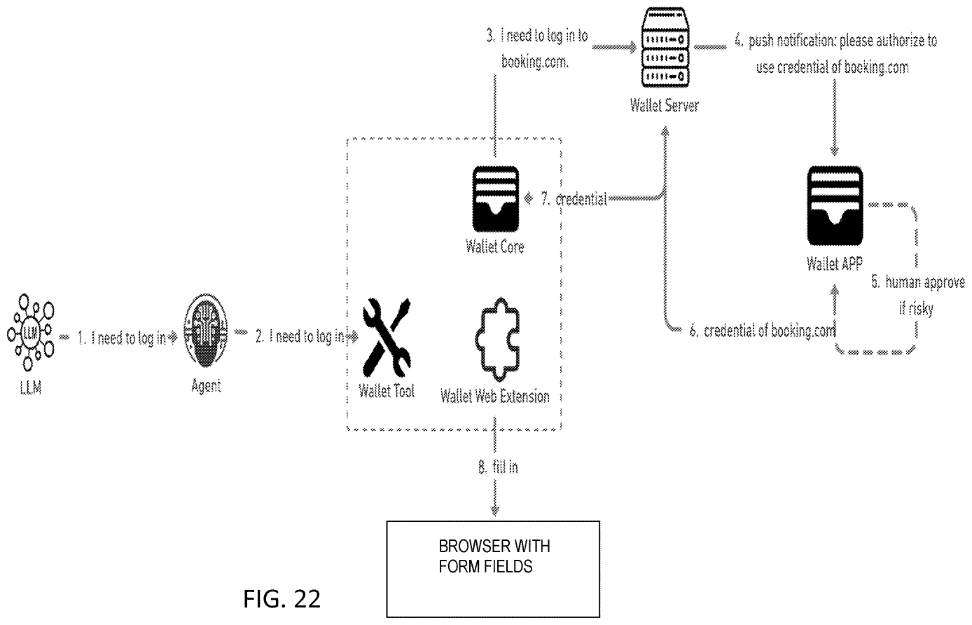

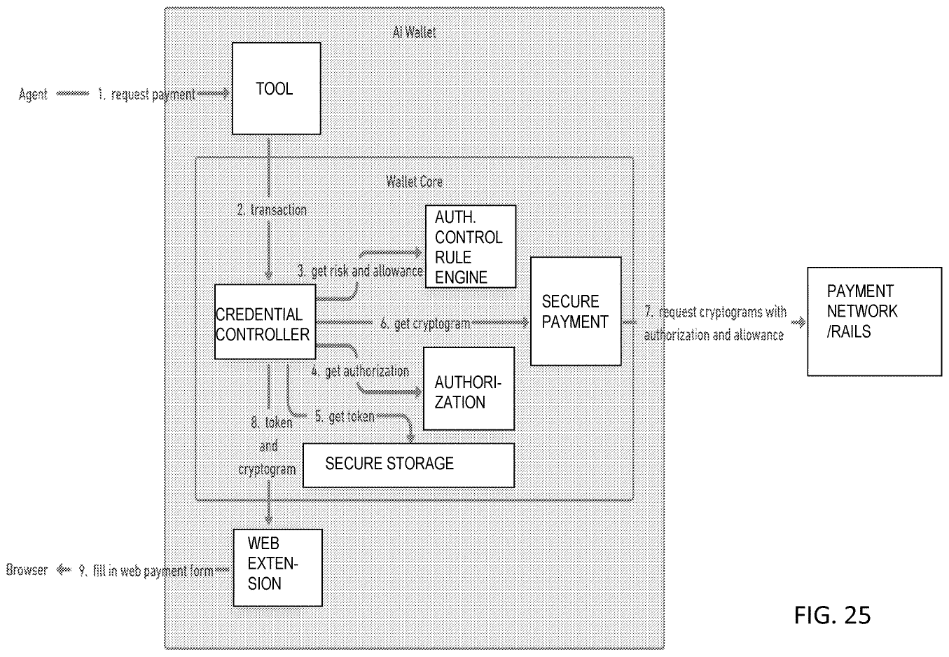

FIGS. 13 through 25 illustrate further embodiments and operational flows of the system. FIG. 13 shows a detailed system architecture, breaking down the wallet core, identity and action services, and their interactions. FIGS. 14, 15, and 16 illustrate different operational modes, including a pure browser mode, a tool mode with web authorization (e.g., OAuth), and a tool mode for machine-to-machine communication protocols, demonstrating the system's flexibility. FIGS. 17, 18, and 19 depict various methods for establishing a secure connection between the agent's computer and the user's mobile device, including Bluetooth, a backend server with a QR code, and a backend server with a connection code. FIG. 20 shows a flow where the agent can operate based on screenshots of the user's browser, enabling interaction with websites that do not have structured APIs. FIG. 21 illustrates a secure, hierarchical keystore architecture, with a Root User Keystore that derives a Service Keystore, which is in turn linked to a Device Keystore, ensuring robust security and key management. FIGS. 22, 23, and 24 provide detailed sequence diagrams for agent-initiated login and authorization flows in both browser and MCP contexts, showing the interactions between the agent, wallet, and backend servers. FIG. 25 details the payment flow, where the agent requests payment, the wallet's credential controller and rule engine evaluate the request, generate a cryptogram and token, and provide them to a web extension to fill a payment form, completing the transaction securely.

In FIG. 13, an example system architecture for enabling an AI agent or large language model (LLM) to securely act on behalf of a user while minimizing consent fatigue. The system includes an Agent/LLM, an AI Wallet deployed on or accessible to the agent, a Wallet App executing on a user mobile device, and one or more external Service Providers. The Service Providers may include web-based services or agent-accessible services, such as booking platforms, commerce platforms, or identity providers. The AI Wallet includes core functional modules, including a tool interface for use by the Agent/LLM, credential management logic, a risk policy engine, authorization logic, secure storage, and secure payment functionality. The Wallet App is responsible for storing sensitive user credentials and approving credential usage, while the Wallet Backend Server optionally facilitates communication between the AI Wallet and the Wallet App when direct connectivity is not available. FIG. 13 further illustrates trust boundaries and separation of responsibilities among components. In particular, the Service Providers do not directly access user credentials, and the Agent/LLM does not permanently store credentials. Instead, credentials are released under policy control from the Wallet App to the AI Wallet only when conditions defined by authorization tokens and risk policies are satisfied.

FIG. 14 illustrates data flows for a Pure Browser Mode, in which a Service Provider exposes only a traditional web user interface designed for human interaction. In this mode, the Agent/LLM simulates human browsing behavior, such as navigating web pages, typing into forms, and clicking buttons, to complete tasks on behalf of the user. When authentication or authorization is required, the Agent signals the AI Wallet that credentials are needed. The AI Wallet, via its Wallet Core, requests the appropriate credentials from the Wallet App, optionally through a Wallet Backend Server. The Wallet App evaluates the request using the applicable risk policy and context information before releasing the credential. Responsive to being approved, the credential is transmitted securely back to the AI Wallet. A web extension component controlled by the AI Wallet injects the credential into the browser context and fills the appropriate login or authorization form. The Service Provider processes the submission as if it were provided by a human user, completing authentication or authorization without exposing credentials directly to the Agent/LLM.

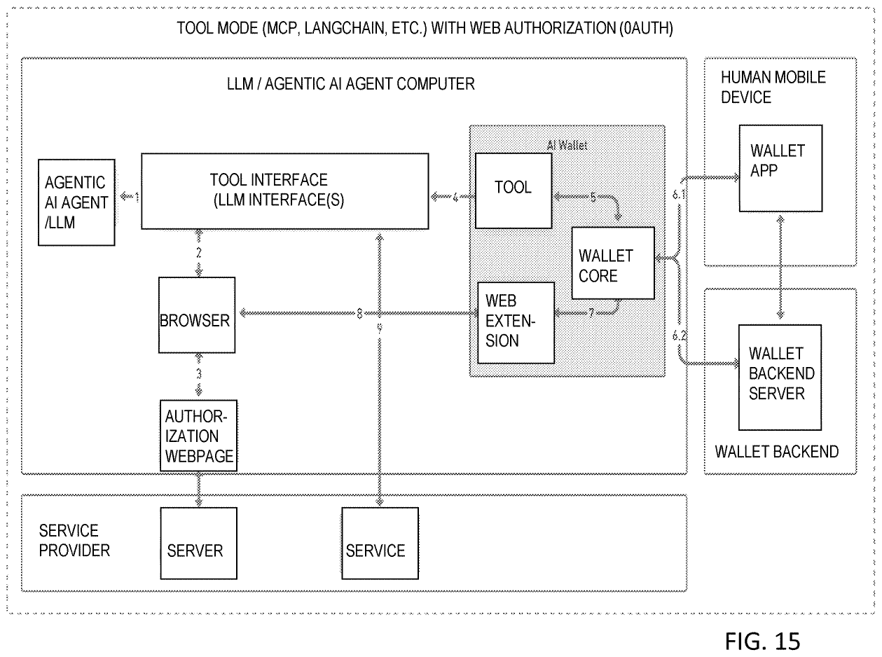

FIG. 15 illustrates data flows for a Tool Mode with Web Authorization, in which the Service Provider exposes agent-accessible interfaces such as Model Context Protocol (MCP) or other APIs, but still relies on browser-based human authorization flows. In this mode, the Agent/LLM initially interacts with the Service Provider directly using tools or APIs. If the Service Provider determines that authorization is required, it returns an authorization challenge, such as an HTTP 401 response with a browser-based consent URL. The Agent directs a browser session to this URL and notifies the AI Wallet that authorization is in progress. The AI Wallet requests credentials from the Wallet App, which applies risk evaluation and may require user confirmation. Responsive to being approved, a browser extension or headless browser controlled by the AI Wallet completes the authorization flow, retrieves access tokens or session credentials, and returns control to the Agent. The Agent can then resume tool-based interaction with the Service Provider using the obtained authorization.

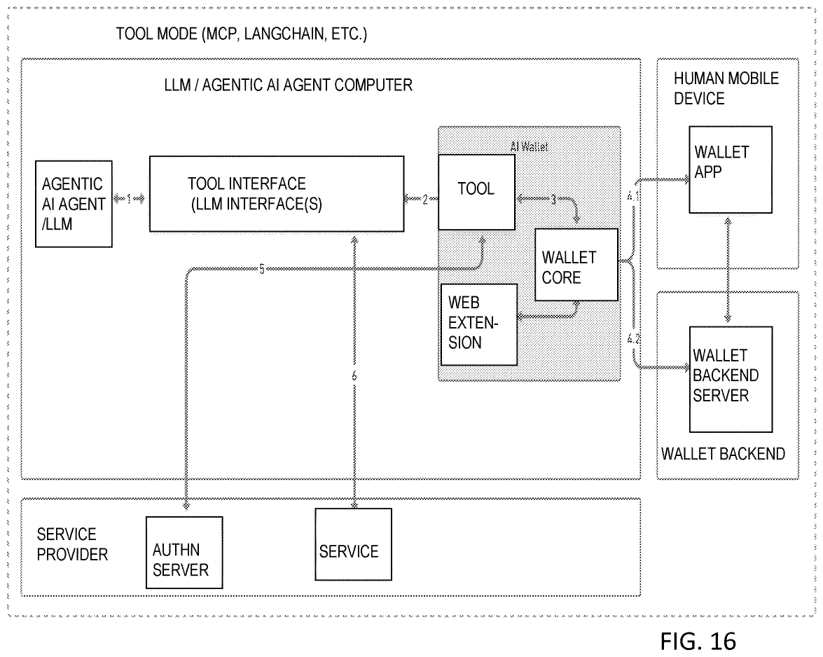

FIG. 16 illustrates data flows for a Pure Tool Mode, in which both authentication and authorization are performed entirely through agent-accessible interfaces without browser involvement. The Service Provider exposes protocols such as MCP that support direct machine-to-machine communication. In this configuration, when the Agent requires access to a protected resource, it notifies the AI Wallet, which constructs an authorization request to the Service Provider. The Service Provider may issue a cryptographic challenge to verify humanity or delegated authority. The AI Wallet coordinates with the Wallet App to obtain credentials and generate required cryptographic proofs, such as challenge signatures. Upon verification, the Service Provider issues an access token directly to the Agent, enabling fully automated task execution without user interface interaction.

FIG. 17 illustrates an example process in which a secure communication channel is established between an Agent Computer and a Wallet App using Bluetooth. This mode is applicable when both components are in physical proximity and Bluetooth hardware is available. In one example flow, the Agent Computer displays a QR code encoding Bluetooth pairing information. The Wallet App scans the QR code to initiate pairing. Once paired, a secure encrypted channel is formed, enabling direct exchange of authorization tokens, risk policies, and credentials. Because communication occurs locally over Bluetooth, this approach is resistant to phishing and intermediary attacks. Authentication and authorization decisions remain under the control of the Wallet App.

FIG. 18 illustrates a secure pairing process using a QR code when the AI Wallet is deployed remotely, such as on a cloud server. The QR code encodes wallet identifiers, connection endpoints, and a one-time secret. After scanning the QR code, the Wallet App establishes a secure channel with the AI Wallet, optionally through a Wallet Backend Server. Sensitive information, including authorization tokens and risk policies, is exchanged only after the channel is established. The figure illustrates how user-verifiable visual information is displayed alongside the QR code to allow the user to confirm the legitimacy of the pairing request.

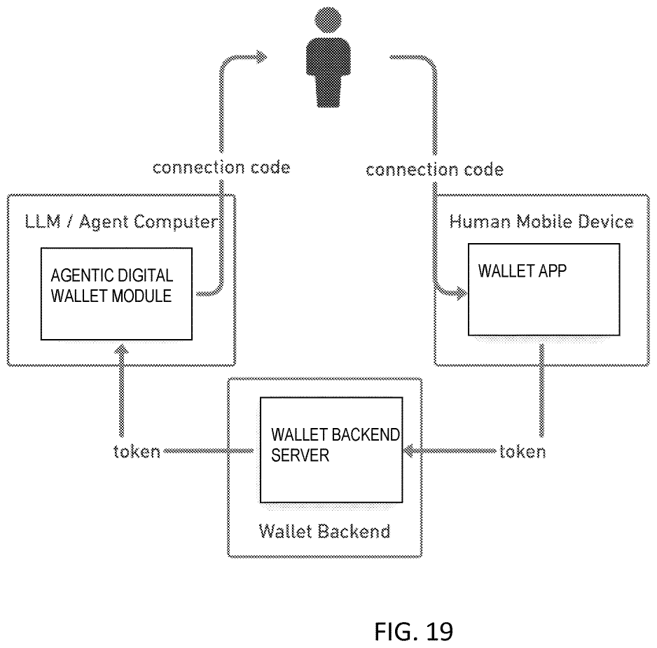

FIG. 19 illustrates a secure channel establishment process using a manually entered connection code. This method is suitable when the AI Wallet exposes only a command-line interface and cannot display graphical QR codes. The connection code encodes a secret used to bootstrap a secure channel. After entry into the Wallet App, additional context information is exchanged over the secured channel. The figure shows how a Wallet Backend Server may facilitate initial message delivery while preserving end-to-end encryption between the AI Wallet and Wallet App.

FIG. 20 illustrates a data flow for handling human verification challenges, such as CAPTCHAs, encountered during browser-based flows. When such a challenge is detected, the Agent suspends automation. The AI Wallet routes the challenge context to the Wallet App, prompting user interaction on a trusted device. After the user completes the challenge, confirmation is relayed back to the Agent. The figure highlights separation between automated steps and human-required actions, preventing automated circumvention of human verification mechanisms.

FIG. 21 illustrates a credential protection architecture featuring multiple keystores. A root user keystore serves as the primary trust anchor and contains all sensitive credentials in encrypted form. Derived service keystores are generated for agent access, containing only authorized credentials and protected by time-limited keys. Device keystores and optional cloud backups provide recovery and redundancy. The figure illustrates how time-based key destruction and regeneration limit exposure in the event of compromise.

FIG. 22 illustrates a step-by-step data flow for credential retrieval and form completion in Pure Browser Mode. The Agent detects a login requirement and requests credentials through the AI Wallet. The Wallet App evaluates the request using risk policies and may prompt the user. Upon approval, credentials are transmitted securely to the AI Wallet. The web extension injects the credentials into the browser and completes the login form, after which the Agent resumes task execution.

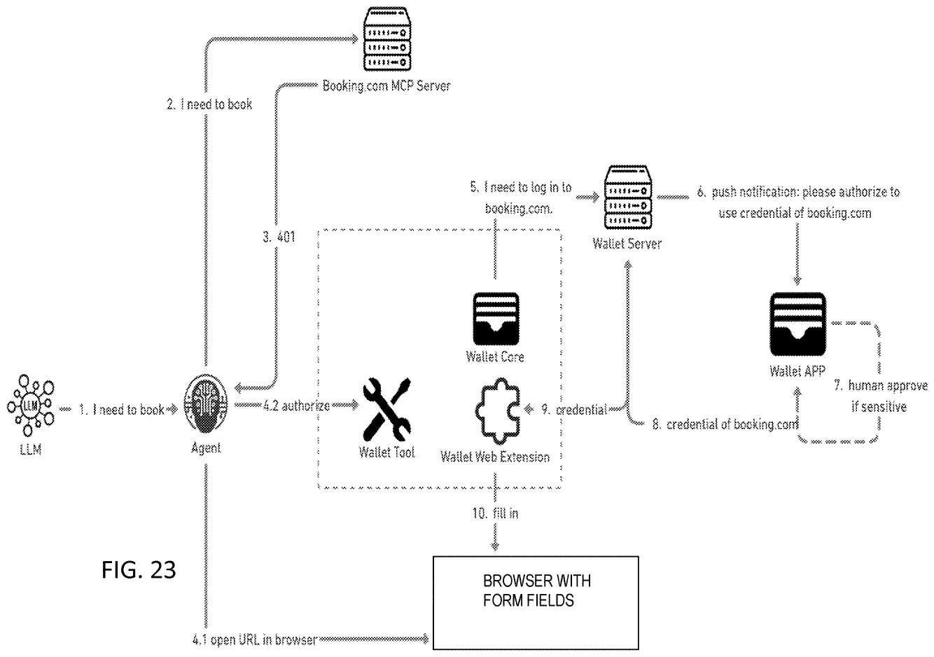

FIG. 23 illustrates credential acquisition in Tool Mode with Web Authorization. After receiving an authorization challenge, the Agent opens a browser authorization flow. The AI Wallet coordinates credential retrieval, applies risk evaluation, and fills authorization forms using a web extension or automated browser. Access tokens are captured and returned to the Agent for continued tool-based interaction.

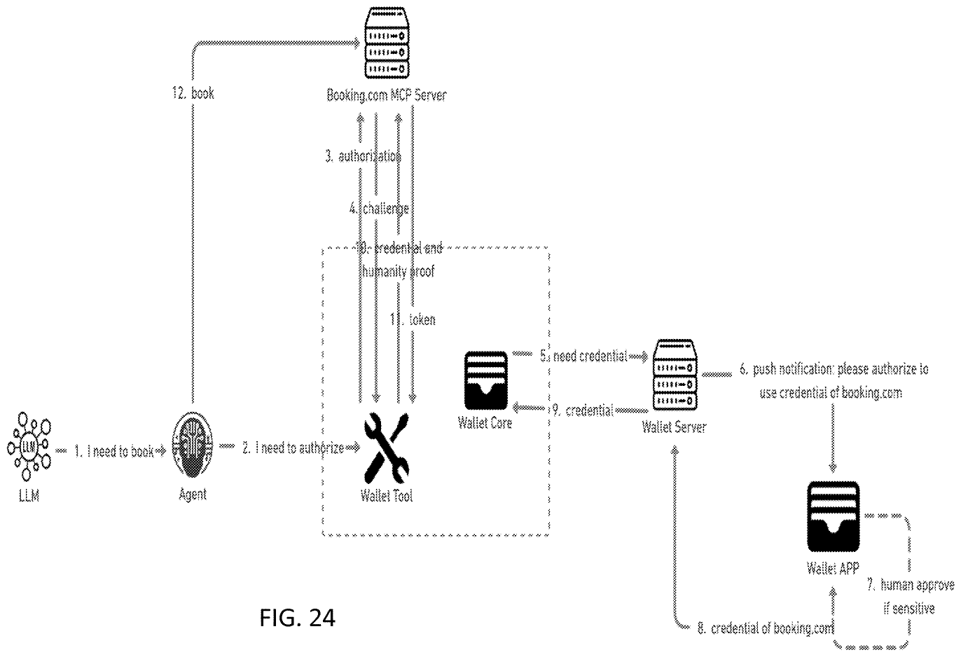

FIG. 24 illustrates credential and access token acquisition in Pure Tool Mode. Authorization requests and challenges occur entirely via agent-accessible interfaces. The AI Wallet generates cryptographic proofs of humanity or delegation using keys backed by biometric authentication in the Wallet App. Upon verification, the Service Provider issues access tokens without browser involvement, enabling full automation.

FIG. 25 illustrates a secure payment process using tokenized payment credentials. When a payment is required, the Agent requests authorization from the AI Wallet. The Wallet App applies spending limits and risk controls before generating a tokenized card number and dynamic verification value. The web extension fills the payment form with limited-scope payment credentials, preventing misuse of full card details while completing the transaction securely.

### Agentic Identity Gateway

Agentic transactions contemplates the use of agentic artificial intelligence (AI) agents that may autonomously log in to websites, browse products, and execute purchases on behalf of users. Existing identity systems, however, are primarily designed for human customers. As a result, autonomous agents lack a first-class identity and are unable to complete standard login flows. Reuse of a user's credentials by an agent is analogous to an impersonation attack, which is prohibited by many service providers. Accordingly, to enable agentic operations in a secure and governed manner, in some cases, each agent is recognized as a distinct, first-class identity having its own credentials, permissions, and audit trail.

In some cases, a system is herein provided that addresses the login problem in agentic operations, such as agentic commerce. An Agentic Identity Gateway is provided that issues a unified identity combining a user account, an agent identity, and a user authorization. This unified identity enables agents to log in to services in a legitimate manner without impersonation, thereby providing a foundation for secure, privacy-preserving agentic commerce.

Existing authentication and authorization mechanisms are predominantly designed for human users. For example, the OpenID Connect (OIDC) protocol authenticates a user and issues ID tokens encapsulating user identity information. In contrast, there is currently no standardized mechanism for authenticating autonomous agents without requiring substantial changes to existing Customer Identity and Access Management (CIAM) systems.

In some cases, the system requires an agent to cryptographically sign HTTP requests to prove its identity. However, such an approach necessitates merchants to implement additional custom logic. Even where such functionality is supported by third-party providers, such as Cloudflare, the adoption of multiple heterogeneous solutions would still require merchants to integrate and maintain multiple authentication methods.

To address these limitations, in some cases, the system provided herein adheres to the following features:

Single integration for merchants—merchants integrate once and remain compatible with diverse agent authentication methods.

Minimal changes to existing CIAM systems—the solution imposes negligible modifications on a merchant's current identity management infrastructure.

Unified authentication-authentication of the user and the agent is combined into a single, streamlined process.

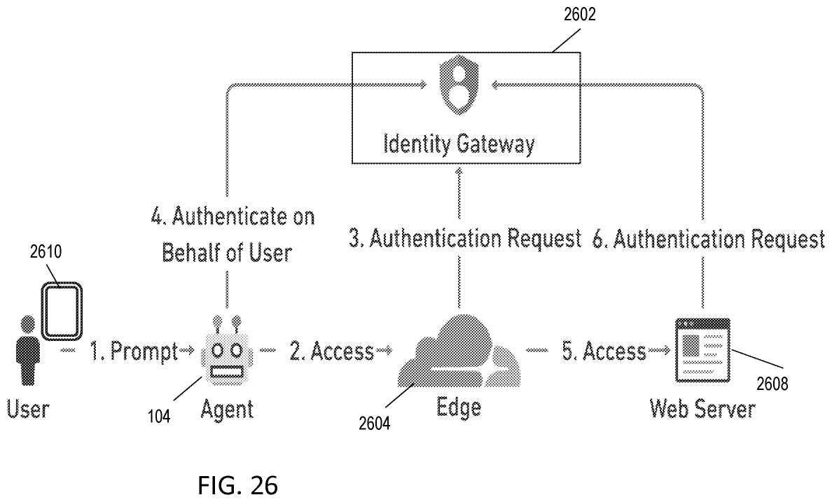

FIG. 26 illustrates the overall architecture of an agentic identity gateway system. A User 2610 provides a prompt to a software Agent 104. To fulfill the user's request, the Agent 104 may need to access a resource hosted on a Web Server 2608. Rather than directly authenticating with the Web Server 2608, the Agent 104 accesses it via an Edge network 2604. An Identity Gateway 2602 is configured to intercept the access request and manage authentication. The Identity Gateway 2602 can authenticate the Agent 104 on behalf of the User 2610, thereby abstracting the authentication logic from the target Web Server 2608 and providing a centralized point of identity control.

The Identity Gateway unifies the authentication of both agents and users, as well as the verification of authorization. At the edge, bot management can rely on the gateway to verify the identities and authorizations of agents and users. Merchants can configure their CIAM system to use the Identity Gateway as an Identity Provider (IdP), enabling authentication for both the user and the agent.

An example process of an agent accessing a website on behalf of a user is illustrated below.
1. The user provides a prompt to the agent to access a website.
2. The agent accesses the website on behalf of the user.
3. The edge identifies the agent and redirects it to the Identity Gateway for authentication.
4. The agent first authenticates itself to the gateway, then authenticates on behalf of the user. It also presents proof of the user's authorization to the gateway.
5. Upon successful verification, the edge receives an ID token from the gateway and grants access
6. When the website requires authentication for both the agent and the user, it redirects the agent to the gateway, continuing from step 4.

In some cases, to support this flow, merchants must configure their CIAM system to recognize the Trusted Service Authority (e.g., LoginID) as a trusted Identity Provider (IdP). They should include a “Sign in with LoginID” option on their sign-in page, which does not need to be visible to end users, as it is intended for agent authentication. When the agent triggers this button, the merchant's CIAM redirects the request to the OIDC endpoint. The OIDC server verifies the agent's identity using supported authentication methods and validates the user's authorization.

Usually the user is authenticated by credentials like passwords, passkeys. The Identity Gateway is compatible with various agent and user authentication methods.

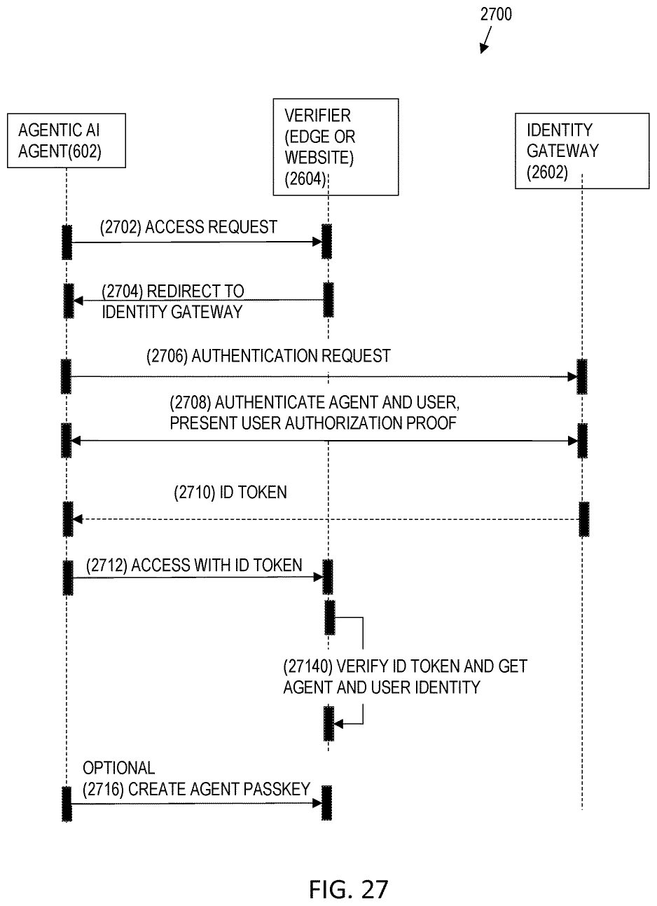

FIG. 27 shows a sequence diagram 2700 illustrating the operation of the agentic identity gateway, which may function as an OIDC (OpenID Connect) server. The process begins when an Agentic AI Agent 602 sends an access request at step 2702 to a Verifier 2604, which may be an edge server or the website itself. The Verifier 2604, not having an active session for the agent or user, redirects the agent to the Identity Gateway 2602 at step 2704. The agent then sends an authentication request to the Identity Gateway 2602 at step 2706. At step 2708, the Identity Gateway 2602 authenticates both the agent and the user, which may involve the agent presenting its user authorization proof, such as the signed authorization object described previously. Upon successful authentication, the Identity Gateway 2602 issues an ID Token 2710 to the agent. The agent can then present this ID Token 2710 to the Verifier 2604 at step 2712 to gain access. The Verifier 2604 verifies the ID token at step 2714 to confirm the identities of both the agent and the user. Optionally, at step 2716, the system may create an agent passkey to streamline future authentications.

In some cases, the agent sign-in process comprises three stages:
1. Initiation—The agent initiates the sign-in process and is redirected by the merchant's CIAM system to the Identity Gateway server.
2. Verification—The Identity Gateway validates the identity of the agent and the user and confirms user authorization.
3. Passkey creation—If the agent is accessing the merchant for the first time, the agent is prompted to generate a passkey following successful sign-in.

In the verification stage, besides traditional authentication methods, like passkey, password, OTP, users can use verifiable credentials (VC) from an identity issuer to pass the authentication. Note that the VC here is not necessarily the W3C VC format. It is a general term which means the identity in the object is verified by an authority. In the VC, the user's name, address, email, phone number can be included. The public key of the user is also included in the VC and signed by the issuer. Therefore, the user can use the corresponding private key to sign the VC presentation and the verifier can verify the presentation and the information included in the VC. VC can help with user sign up. When the user signs up, the user can present the VC to the merchant so that the merchant can verify the user's name, address and email. VC can also help with the user sign in. The merchant can use the email or phone number in the VC to associate the user with an existing account.

When the agent signs in on behalf of the user for the first time, the agent can present the VC to prove it is on behalf of the owner of the email address. Therefore, the merchant can link this agent to the user's account. After the first time sign in, the agent can create a passkey for the future sign-in.

Following authentication, an ID token is returned to the merchant. This token conveys the identity of the agent, the identity of the user, and the authorization granted by the user. This ID token can be in any format, for example extended OpenID ID token or Verifiable Credential. The following is just one example of the ID token. Note that authorization proof is signed by the agent's private key to prove this agent has the private key that corresponds to the public key in the authorization_cert. The basic idea of this ID token is to show user identity, agent identity, user authorization and the token is signed by an authority who verifies the identities and authorization.

User Passkey and Agent Passkey

```
{
  agent: {
    name: $name,
    domain: $domain,
    manufacturer: $manufacturer,
    public_key_url: $url,
    contact_email: $contact_email,
  },
  authorization_cert: {
    user_identity: {
      user_id: $id,
      email: $email,
      phone: $phone,
      address: $address,
    },
    agent_identity: {
      name: $name,
      domain: $domain,
      manufacturer: $manufacturer,
      public_key_url: $url,
      contact_email: $contact_email,
    },
    signature_algorithm: {
      hash: $hash_algorithm,
      signature: $signature_algorithm,
    }
    issued_date: $timestamp,
    expiry: $time,
    nonce: $randomnumber,
    signature: $blob,
  },
  authorization_proof: {
    time: $timestamp,
    nonce: $randomnumber,
    signature_algorithm: {
      hash: $hash_algorithm,
      signature: $signature_algorithm,
    },
    signature: $blob,
  }
}
```

To distinguish between actions initiated by a user and those initiated by an agent, merchants preferably issue separate credentials for users and agents. As used herein, the term credential is employed in a broad sense and may include passwords, passkeys, one-time passwords (OTPs), and other authenticators. Provided that user credentials and agent credentials are distinct, the system is able to differentiate between user-initiated behavior and agent-initiated behavior.

A passkey is one example of a credential and provides enhanced security and usability relative to traditional authentication mechanisms. Attestation data associated with passkey usage may be leveraged to verify that a passkey operation genuinely originated from a human user. In particular, user presence (UP) and user verification (UV) flags included within the attestation data may serve as evidence that the operation was performed by a real user.

Additionally, credential managers preferably enforce isolation between user credentials and agent credentials, thereby preventing misuse of one party's credentials by the other.

### Privacy-Preserving User Identity Linking

An important function of an ID token is to establish a binding relationship between a user and an agent. This binding enables a merchant to detect potential Sybil attacks, in which a single user controls multiple agents in order to access a service. As discussed further in the Agent Reputation System, it is desirable to preserve uniqueness of user identity across different merchants so that misbehaving users or agents may be identified and blacklisted.

However, enforcing identity uniqueness across merchants presents significant privacy concerns. Even where a user identifier is represented as a pseudorandom value, an attacker may still be able to correlate activities across multiple merchant platforms to the same individual. To reconcile the competing goals of preserving user privacy while enabling blacklist verification of a user-agent pair, the following identity system is disclosed.

When a user creates an account at a first merchant (merchant1), the user is redirected to an Identity Gateway.

The Identity Gateway verifies the user's real-world identity using identity verification (ID&V).

Upon successful verification, the Identity Gateway generates a globally unique identifier (GUID) for the user based on the user's real-world identity.

The Identity Gateway then applies a merchant-specific mask to the GUID to generate a merchant-specific user identifier (MSUID), which is returned to merchant1.

If the same user subsequently attempts a Sybil attack, the Identity Gateway returns the same MSUID to merchant1, enabling immediate detection by merchant1.

Thereafter, merchant1 refers to the user using the MSUID. Notably, a different merchant (e.g., merchant2) receives a different MSUID for the same user.

The generation of the merchant-specific mask is critical to preserving user privacy. A static mask shared across all users of a merchant is not suitable, as such a mask could potentially be inferred by the merchant and used to recover the underlying global user identifier (GUID).

To mitigate this risk, the mask is preferably derived using both a merchant-specific secret and the user's identity. One illustrative construction is expressed as:

mask=Hash(user identity,merchant secret)

where the merchant secret is a randomly generated value unique to each merchant. In one embodiment, only the Identity Gateway has access to the merchant secrets.

### Generate Payment Encrypted Bundle and Complete Payment

According to the authorization control rule engine, transactions are classified into two categories: auto-authorized transactions and human-authorized transactions. Each category follows a distinct workflow.

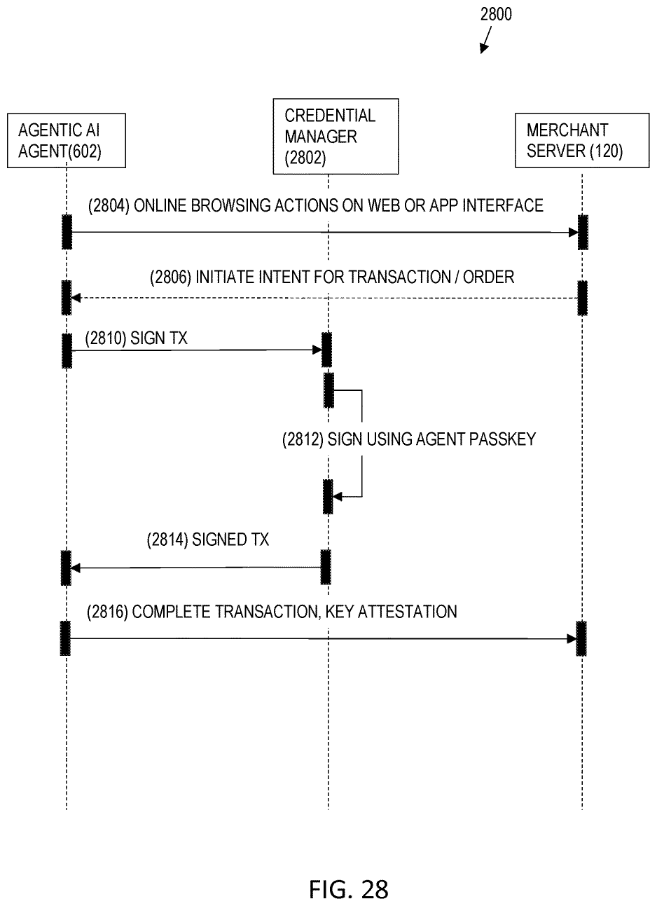

FIG. 28 shows a sequence diagram 2800 for an auto-authorized transaction workflow. An Agentic AI Agent 602 performs online browsing actions on a web or app interface of a Merchant Server 120 at step 2804. At step 2806, the agent initiates an intent for a transaction or order. This triggers a request to a Credential Manager 2802, which may be a component of the agentic wallet, to sign the transaction at step 2810. Because the transaction is auto-authorized by the wallet's authorization control rules engine, the Credential Manager 2802 signs the transaction using an agent passkey at step 2812, generating a signed transaction 2814. This signed transaction is returned to the agent, which then completes the transaction with the Merchant Server 120 at step 2816, which may include providing a key attestation to prove the integrity of the signing key.

When the po authorization control rules engine classifies a transaction as low risk, the agent may authorize the transaction autonomously. In this case, the transaction is signed using the agent passkey that was created during the agent's initial registration with the merchant. Because the agent passkey functions as a silent authenticator, the transaction can be completed without requiring user intervention.

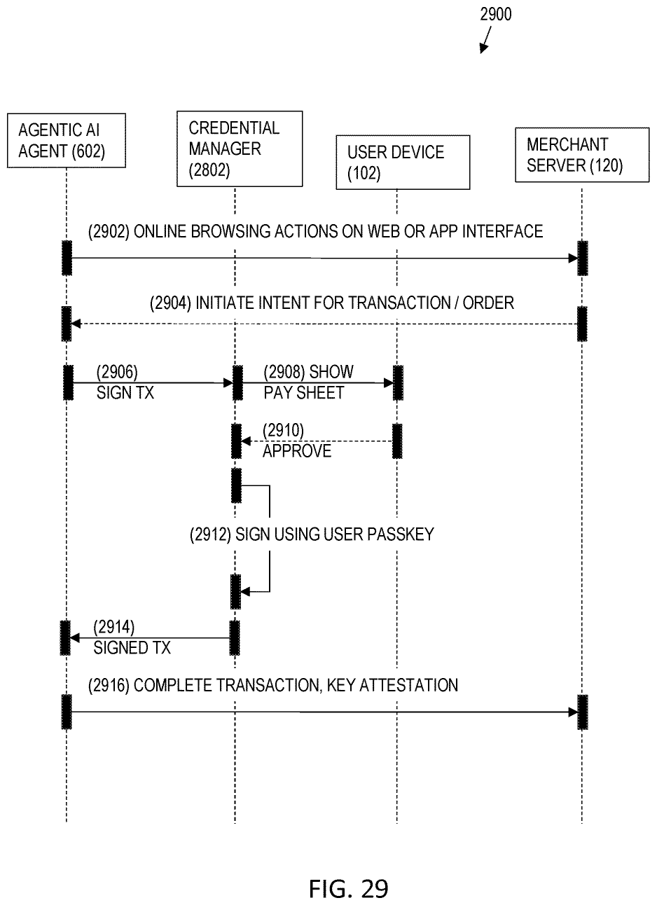

FIG. 29 shows a sequence diagram 2900 for a human-authorized transaction workflow, which contrasts with the auto-authorized flow. The initial steps 2902 and 2904 are similar, where the Agentic AI Agent 602 initiates a transaction intent with the Merchant Server 120. When the agent requests the transaction be signed at step 2906, the Credential Manager 2802 determines that human approval is required. It sends a request to the User Device 102 to show a pay sheet at step 2908. The user reviews the details and provides an explicit approval at step 2910. This approval triggers the signing of the transaction using a user passkey at step 2912. The resulting signed transaction 2914 is then used by the agent to complete the transaction with the Merchant Server 120 at step 2916.

In some cases, for high-risk transactions, explicit human approval is required. Such transactions are signed using the human passkey, which provides proof of human presence as part of the authorization process

### Agent Reputation System

In some cases, a function of the identity gateway is agent governance: in addition to verifying identities, it distinguishes between trustworthy and malicious agents. This implemented through an agent reputation system. Merchants and service providers can submit feedback about an agent's behaviour, such as fraudulent actions or policy violations. The identity gateway links each report to the appropriate agent-user pair via the masked user identifiers and aggregates these reports across merchants. Because each merchant sees a different MSUID for the same user, colluding merchants cannot reconstruct the user's identity, yet the gateway can detect patterns of abuse across the ecosystem. Agents with higher reputation scores will face fewer login barriers, while those with poor scores may be challenged or rejected. This reputation system provides a scalable, privacy?preserving way to build trust in agentic commerce.

When merchants report misbehaved agent-user pairs, the merchant reports the MSUID back to the Identity Gateway. The identity gateway converts MSUID back to GUID.

### Agent Friendly Captcha

With agentic commerce, CAPTCHA's role should evolve from blocking bots to identifying whether the actor is a human or an AI agent. Responsive to an agent being recognised, the CAPTCHA automatically hands off the decision to the identity gateway. The identity gateway uses the unified identity and the agent's reputation score to determine whether to allow the agent to proceed, require additional verification, or deny access. This approach treats CAPTCHAs as identification tools rather than barriers.

The identity gateway address challenges to agentic commerce: giving agents a secure, first?class identity that allows them to log into merchant sites without impersonating users. The unified identity binds together the user's account, the agent's identity, and the user's authorization for the agent. To protect privacy, the system derives unique, per?merchant masked identifiers so merchants cannot collude to reconstruct the user's identity. The identity layer supports passkey?based transaction approval for both user?controlled and agent?controlled keys, with platform attestation to distinguish between them. The agent reputation system builds trust across the ecosystem. In some cases, the agent?friendly CAPTCHA identifies agents instead of blocking them and relies on the identity gateway and reputation system to make access decisions. These improvements provide secure and privacy?preserving logins in agentic commerce.

### Agentic AI Agent Operation

Merchant computing systems (or merchant computing environments) vary widely in their level of agentic readiness. They can be broadly categorized into three types:
(1) API merchants, which expose traditional APIs. The agent communicates to the merchant through API, which is deterministic and has the best accuracy. It is robust and efficient. However, APIs lack flexibility. Different merchant computing systems implemented different APIs. Therefore, the agent has to implement different API clients for different merchants.
(2) Agent-ready merchants, which implement at least one agentic protocol (e.g., MCP, A2A) to enable direct agent shopping interactions. Communicating to a merchant computing system through MCP doesn't require the agent to implement specific APIs. An LLM can figure out when and how to call the service through the nature language description. Similar to MCP, A2A doesn't require the agent to implement anything. Moreover, A2A has the discovery capabilities, which allows agents to talk to other unknown agents directly.
(3) Human-UI-only merchants, which restrict transactions to graphical user interfaces such as websites or mobile apps. This type of merchant computing system doesn't implement any non-human interfaces.

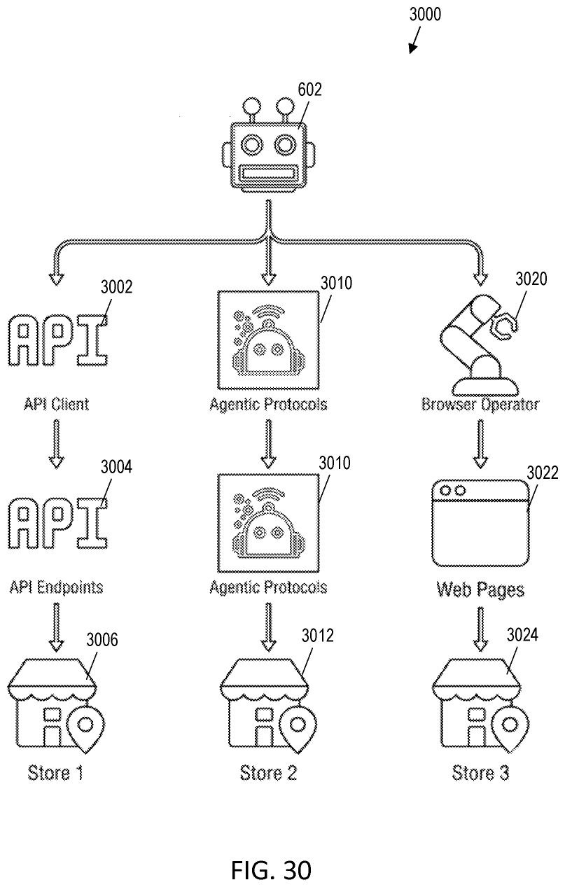

Some of the different types of merchant computing systems are shown in FIG. 30. In particular, FIG. 30 illustrates a system 3000 showing the different operational communication interfaces an Agentic AI Agent 602 can use to fulfill e-commerce operations. The agent can interact with different merchants, such as Store 1 (3006), Store 2 (3012), and Store 3 (3024), using the most efficient interface available. The available interfaces include: a dedicated API Client 3002 that communicates with structured API Endpoints 3004; a standardized Agentic Protocol 3010 for machine-to-machine communication; or a Browser Operator 3020 that automates interactions with standard Web Pages 3022. The agent's ability to select from these interfaces provides significant operational flexibility.

A computing system is herein provided that is configured as unified system architecture that enables an agentic AI agent (herein sometimes called “AI agent”) to interoperate seamlessly across different types of merchant computing systems (e.g., all three merchant types). In other words, the same agent can interact with the different types of merchant computing systems. In some cases, the computing system configuration focuses particularly on data and communication interactions with human-UI-only merchants, which present unique challenges due to the absence of programmable interfaces. The computing system introduces fast and robust methods for data extraction and interaction through human interfaces, mechanisms for incorporating agent-provided contextual information without degrading user experience, and techniques for reliably distinguishing between agent-initiated and human-initiated operations.

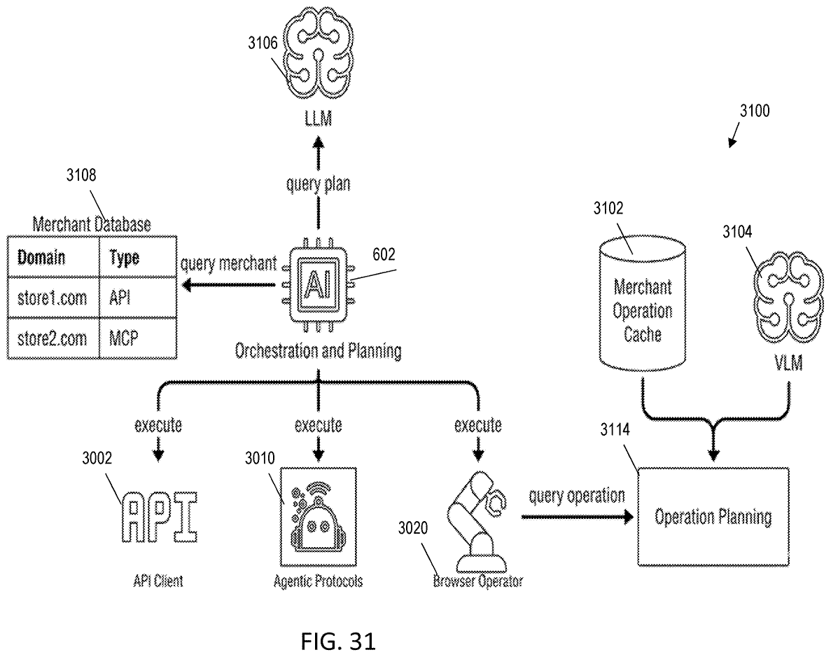

FIG. 31 illustrates a system 3100 for the orchestration and planning of agent operations. An orchestration module or an Agentic AI Agent 602, which may be controlled by a Large Language Model (LLM) 3106 that generates a query plan, selects the appropriate operational interface. The agent queries a Merchant Database 3108 to determine if a known interface (e.g., API, MCP) exists for a target merchant. The agent can then execute the operation using the selected interface, such as the API Client 3002, Agentic Protocols 3010, or Browser Operator 3020. For browser-based operations, a Vision Language Model (VLM) 3104 may be used to interpret web page layouts to formulate an operation plan, which can be improved by querying a Merchant Operation Cache 3102 that stores information from previous interactions.

In some cases, as per FIG. 31, the computing system includes an Orchestration Module, which is responsible for planning and coordinating all agentic commerce operations. In some cases, the Orchestration Module is the control layer that determines what the agent should do next and how to interact with external systems. The orchestration module queries the Large Language Model (LLM) to decide the next operational step, and consults the Merchant Database to determine the most suitable communication interface for a given merchant. In some cases, the orchestration module is part of the Agentic AI Agent 602. In some other cases, the orchestration module is separate from the agent and communicates with the Agentic AI Agent 602.

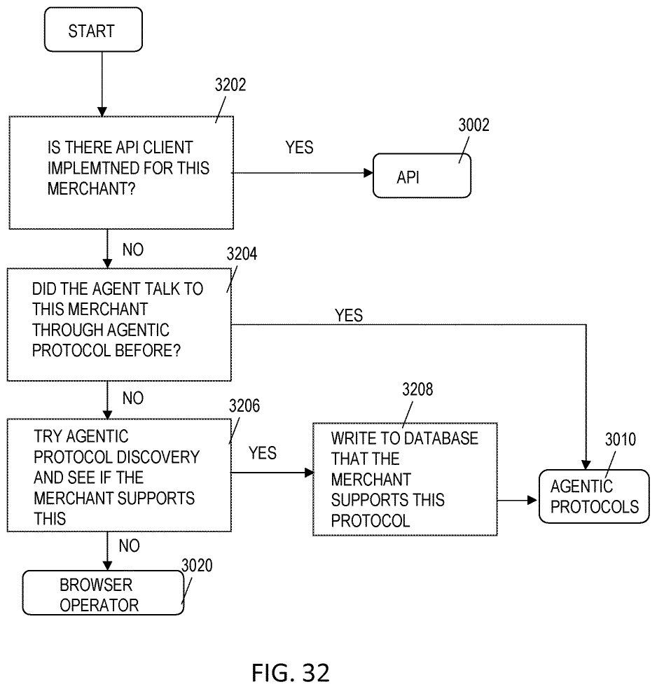

FIG. 32 is a flowchart detailing the agent's process of selecting an operational communication interface. The process starts at decision block 3202, where the agent checks if a dedicated API Client 3002 has been implemented for the target merchant. If so, the API is used. If not, the process moves to decision block 3204, where the agent checks its history to see if it has previously communicated with the merchant via an Agentic Protocol 3010. If so, that protocol is used. If not, the agent attempts agentic protocol discovery at step 3206 to see if the merchant supports such a protocol. If discovery is successful, the agent uses the Agentic Protocol 3010 and may write this information to a database for future use at step 3208. If no structured interface is found, the agent defaults to using the Browser Operator 3020 as the interface.

When a merchant computing system provides an API interface and the agent implements the corresponding API client, the orchestration module establishes communication through those APIs. If the merchant supports one or more agentic protocols (such as MCP, A2A), the agent can interact directly with the merchant via those standardized channels. In cases where neither an API nor an agentic protocol is available, the system falls back to a web browser or mobile app operator. This web browser or app operator automates the merchant's user interface to complete the transaction. In some cases, the computing system primarily uses the Web UI operator as an example to demonstrate how the fallback mechanism works. However, the same principles and techniques apply to mobile app environments, with adaptations for their respective UI frameworks and interaction models.

The agent maintains an internal Merchant Capability Database that records whether a given merchant computing system supports APIs or any agentic protocols. This database enables the agent to quickly determine the most appropriate communication interface when interacting with a merchant.

If a merchant computing system already has an entry in the database, the agent can directly select the corresponding interface-either API-based or agentic protocol-based-without additional probing. However, if no record exists for a merchant, the agent initiates an agent protocol discovery process to identify the merchant's supported capabilities.

In some cases, computing system is configured to use the communication protocols: the Model Context Protocol (MCP) and the Agent-to-Agent (A2A) protocol. Both protocols enable communication between agents and merchant systems. The Agentic Commerce Protocol (ACP), while closely related to agentic commerce, is fundamentally API-based rather than agent-based, and therefore is not classified as an agentic protocol in this context.

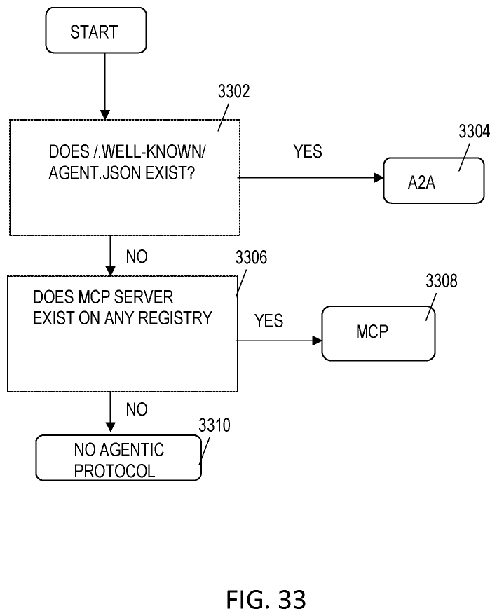

FIG. 33 is a flowchart illustrating the agentic protocol discovery process. At step 3302, the agent first checks for the existence of a well-known URI, such as/.well-known/agent.json, which indicates support for an Agent-to-Agent (A2A) protocol 3304. If this is not found, the agent queries a registry at step 3306 to determine if the merchant has a registered server for a Machine-to-machine Communication Protocol (MCP) 3308. If neither of these discovery methods is successful, the agent concludes that no agentic protocol is supported at step 3310.

In FIG. 33, in some cases, step 3302 and step 3306 are each implemented as protocol detector. A detector takes the merchant's domain name as input and outputs whether a specific agentic protocol is supported. Because both Agent Cards and MCP servers often describe their capabilities using natural language, each detector relies on a LLM to interpret and evaluate the merchant's service description. The LLM determines whether the detected protocol is relevant to agentic commerce. If a merchant appears to support a protocol-such as agent-to-agent (A2A)—but its implementation is unrelated to agentic commerce (for example, it is used for internal system communication or unrelated automation), the detector's output remains negative. In other words, in some cases, the detector only returns “supported” when the identified protocol is both present and functionally applicable to the given tasks.

### Hierarchical Browser Operator

The browser operator serves as the fallback mechanism when no API or agentic protocol is available. It enables the agent to complete transactions through the merchant's human interface.

There are two primary methods for operating the browser:

DOM Parsing Method—This approach is similar to traditional web crawlers. It analyzes the Document Object Model (DOM) structure of the webpage to identify elements and perform automated actions such as clicking buttons or filling forms. The main advantage of this method is its high efficiency, as it directly manipulates the DOM without requiring visual processing. However, its robustness and flexibility are limited: when the web page structure changes, the operator must be updated accordingly.

Vision-Language Model (VLM) Method—In this approach, a Vision-Language Model interprets the webpage visually, “understanding” its layout and content in a human-like manner before performing the corresponding actions. Although this method is slower due to the computational cost of the VLM, it offers superior adaptability and can handle previously unseen or dynamically generated websites.

In some cases, to achieve both speed and robustness, the computing system combines the two methods. The computing system first attempts fast DOM-based operations; if the page structure cannot be parsed or validated, the operator falls back to the VLM-based interpretation to complete the interaction. This hybrid strategy enables efficient yet resilient browser operation across a wide range of merchant websites.

The recognition of webpage elements can generally be approached through three categories of methods.

Rule-based methods: These approaches rely on manually defined rules derived from webpage source code analysis, such as template matching, keyword matching, or hardcoded CSS selectors. Their primary advantage lies in computational efficiency. However, they suffer from limited generality and robustness, as rules crafted for one webpage are rarely transferable to others, and even minor modifications to a page may render existing rules obsolete. If the page is changed, the original template or CSS selector may fail to find the element. Therefore, this method will return an error, and continue to try the small model method.

Small-model methods: In this context, “small models” refer to traditional machine learning techniques, such as support vector machine (SVM), decision tree, random forest, etc. While slightly less efficient than rule-based methods, they offer improved generality. Once trained, such models can generalize across a broader spectrum of web UI elements. However, because of the limitation of the training data, there will be elements that can't be recognized by the small model. In that case, the model will return an error or a result with a very low confidence score.

Vision-Language Model (VLM) methods: Contemporary webpage-operating agents, such as Browser Use, frequently employ VLMs. These models are capable of handling highly diverse input conditions, but their application is often constrained by significant computational overhead.

To balance efficiency and generality, the computing system is configured to execute a hierarchical strategy. The computing system first attempts template matching; if no suitable template exists or the operation fails, the process falls back to a small-model method. Should this approach also fail, the computing system invokes a VLM. In cases where the VLM succeeds, the newly acquired template is incorporated into the repository for future reuse. In some cases, this repository is called the cache of operations.

### Transmitting Extra Data Through Human Interface

Autonomous agents are inherently capable of providing richer forms of information than human users. For instance, they can generate cryptographic signatures to ensure data integrity, a task that is computationally infeasible for humans to perform manually. Nevertheless, the utility of such capabilities is constrained by the design of human-oriented interfaces, which are typically limited to the types of input that human users can feasibly supply. In some cases where websites do not expose dedicated APIs for agents, there exists no effective mechanism to transmit this additional information.

To address this limitation, the computing system introduces or includes hidden fields as a communication channel for agent-provided metadata. These fields remain invisible to human users and therefore do not alter the user experience, yet they are accessible to agents through webpage source code inspection and can be programmatically manipulated. Potential applications of this mechanism include, but are not limited to, the submission of digital signatures and the verification of agent identities.

### Humanity Proof

When agents act on behalf of users-shadowing their identities—it becomes critically important to ensure that all authorization and confirmation actions originate from a real human. Without this assurance, the system may be vulnerable to unauthorized or automated misuse.

To generate verifiable proof of humanity, the computing system binds human verification to a cryptographic key. Most modern platforms support the creation of cryptographic keys that are tied to biometric authentication-such as fingerprint or facial recognition. The attestation information associated with these keys can be used to prove that the key is securely stored in hardware (e.g., Secure Enclave or Trusted Execution Environment) and that access to the key requires successful biometric authentication. Any authorization token signed by this key is considered from a human. Different platforms implement key creation and attestation mechanisms in distinct ways, which affects the strength and semantics of humanity proof. For example, on iOS (an operating system from Apple), it is possible to create cryptographic keys that require biometric authentication each time the key is used. The attestation can also confirm whether the key is hardware-backed and protected by biometric verification. On Android, while it is also possible to bind keys to biometric authentication during creation, the attestation proves that biometric verification was performed at the time of key generation—not necessarily during each subsequent use. Based on the varying capabilities of attestation mechanisms across platforms, the computing system stores and utilizes three levels of assurance for humanity proof:

| Assurance | |
|---|---|
| Level | Explanation |
| Level 1 | The creation and use of keys require biometric |
| | verification and attestation can prove it. |
| Level 2 | The creation of keys requires biometric |
| | verification and attestation can prove it. |
| Level 3 | Biometric verification is not required. |

Humanity Proof Protocol Flow. The process for generating and verifying proof of humanity in the system proceeds as follows:
1. Key Generation
   The AI Wallet generates a cryptographic key pair: (pk1, sk1).
   The Wallet App generates its own key pair: (pk2, sk2), and obtains an attestation proving that usage of sk2 (the private key) is protected by biometric authentication (e.g., Face ID, fingerprint). Note that the attestation result is associated with pk2.
2. Authorization Binding
   To authorize the AI Wallet, the Wallet App signs pk1 with sk2, producing a signature sig (sk2, pk1).
   The Wallet App returns the following to the AI Wallet:
      pk2
      sig (sk2, pk1)
      Attestation result for pk2 (proving it is bound to biometric authentication)
      Authorization token
3. Humanity Verification (MCP Server)
   When the MCP server needs to verify that an agent action is authorized by a human, it issues a random challenge to the AI Wallet.
   The AI Wallet signs the challenge with sk1.
   The Wallet App sends the following to the MCP server:
      The challenge signature: sig (sk1, challenge)
      The corresponding public key: pk1
      The previously issued attestation for pk2
      The signature binding: sig (sk2, pk1)
4. Verification by MCP Server
   The MCP server performs the following checks:
      Validates the attestation to ensure that pk2 is associated with a key (sk2) that requires biometric authentication.
      Verifies that pk1 was signed by sk2, establishing that pk1 was authorized by a human-verified device.
      Verifies that the current challenge was signed by sk1, confirming that the AI Wallet holds the private key corresponding to pk1.

Through this chain of trust, the MCP server can confidently infer that the AI Wallet is acting on behalf of a real, verified human.

In some advanced use cases, preserving user unlinkability becomes critical. The previously described mechanism uses a signing public key that, by design, allows the linking of multiple operations to the same human entity. While this is acceptable in most cases, full unlinkability is desirable in sensitive or adversarial environments.

To achieve this, the computing system includes a zero-knowledge-based extension using ring or group signatures. This allows an agent to prove that a signature was created by one of a group of possible keys, without revealing which one, thereby preserving privacy.

Modern identity systems, such as those using passkeys, enforce strong key protection. Private keys are hardware-bound and unexportable. The cryptographic algorithms (e.g. ECDSA, EdDSA) are fixed and cannot be substituted.

This imposes constraints that prevent the direct use of zero-knowledge signature schemes like zk-SNARKs or custom anonymity-preserving protocols. The computing framework proposed here can work together with hardware protected private keys and standard algorithms.
1. Key Generation: Each user generates a standard asymmetric key pair using passkey interface or directly using secure hardware (e.g. TPM, Secure Enclave). The public key is exported; the private key remains protected.
2. Ring Signature Construction: A ring signature or group signature is constructed using:
   Signature algorithm.
   The user's public key.
   A pool of other unrelated public keys encoded in publicly available cryptography materials.
Construction follows methods compatible with the standard signature scheme (e.g. ECDSA), such as [1] for construction techniques compatible with ECDSA. This framework doesn't restrict how to construct ring or group signatures. The way described in [1] can be replaced by any other methods.
3. Publishing Cryptographic Material: The set of all public keys used to form the ring is published as the public cryptographic material. No linking between individual public keys and their origin is possible from this material alone.

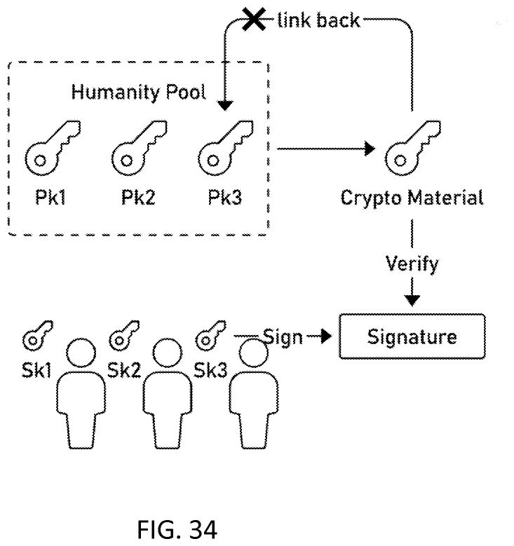

The agent signs the message (e.g., a challenge) using their standard signature algorithm (e.g., ECDSA). This signature is augmented into a ring signature, proving membership in the public key pool without revealing which key was used. See FIG. 34.

FIG. 34 illustrates the concept of a ring signature, which can be used to prove membership in a group without revealing which member generated the signature. In this embodiment, a user's secret key (e.g., Sk1, Sk2, or Sk3) is used along with the public keys of other members in a “Humanity Pool” (Pk1, Pk2, Pk3) to generate a Signature on some Crypto Material. A verifier can use the public keys of the entire pool to verify that the Signature was generated by a valid member of the pool, but cannot determine which specific member it was. This mechanism can be used to prove “humanity” or user involvement in a privacy-preserving manner, as the resulting signature does not link back to the specific individual who signed it.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g. a pushbutton keyboard, mouse, a touchscreen, and the like), and at least one output device (e.g. a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A computing system for managing agent-initiated transactions, the system comprising a processor and a memory storing instructions that, when executed by the processor, configure the system to comprise:
an authorization module configured to, based on a user's consent, authorize a software agent by generating a signed authorization object that cryptographically binds a verified identity of the software agent to a user's identity;
an authorization control rule engine configured to:
receive a transaction request from the authorized software agent, the transaction request pertaining to a purchase from a merchant; and
evaluate the transaction request against a set of rules to determine whether to autonomously approve the transaction without requiring real-time user confirmation; and
a token requester module configured to, in response to the authorization control rule engine autonomously approving the transaction, request a restricted-use payment token from a payment network system, wherein the request includes one or more transaction constraints derived from the evaluation by the authorization control rule engine.

2. The system of claim 1, wherein the authorization control rule engine is configured to evaluate the transaction request by applying a set of learned rules derived from a history of transactions previously approved by the user, and, in response to determining that no learned rule from the set of learned rules applies, applying a set of pre-set, risk-based rules.

3. The system of claim 2, wherein the set of pre-set, risk-based rules defines different transaction amount thresholds for autonomous approval based on a determined risk level associated with the merchant.

4. The system of claim 1, wherein the one or more transaction constraints included in the request for the restricted-use payment token comprise at least one of: a merchant category, a maximum transaction value, and an identifier of the software agent, thereby enabling the payment network system to enforce the constraints during transaction processing.

5. The system of claim 1, wherein the authorization control rule engine is further configured to: receive a single user approval for a high-level transaction intent, the intent comprising a plurality of planned sub-transactions; and autonomously approve a plurality of individual transaction requests received from the software agent, wherein each individual transaction request corresponds to one of the planned sub-transactions covered by the single user approval.

6. The system of claim 1, wherein the authorization control rule engine is further configured to: receive a single user approval for a high-level transaction intent, the high-level transaction intent defining constraints for a plurality of related sub-transactions; and for each of the plurality of related sub-transactions, receive a corresponding individual transaction request from the software agent and, in response to validating that the individual transaction request complies with the constraints, generate an agent-approved transaction object that includes a reference to the high-level transaction intent, thereby establishing a verifiable cryptographic linkage between the agent-approved transaction object and the single user approval.

7. The system of claim 6, wherein: the high-level transaction intent is comprised within a user-approved transaction object that is cryptographically authorized by a digital signature from the user; and each agent-approved transaction object is independently and cryptographically authorized by a digital signature from the software agent without requiring an additional digital signature from the user for the respective sub-transaction.

8. A computer-implemented method for managing agent-initiated transactions, the method comprising: authorizing, by a computing system, a software agent by generating, based on a user's consent, a signed authorization object that cryptographically binds a verified identity of the software agent to a user's identity; receiving, by the computing system from the authorized software agent, a transaction request for a purchase; evaluating, by a policy engine of the computing system, the transaction request against a set of policies to determine whether to autonomously approve the transaction without requiring real-time user confirmation; and in response to autonomously approving the transaction, requesting, by the computing system, a restricted-use payment token from a payment network system, wherein the request includes one or more transaction constraints derived from the evaluation.

9. The method of claim 8, wherein evaluating the transaction request comprises: first, applying a set of learned rules based on a user's transaction approval history; and second, if no learned rule applies, applying a set of pre-set, risk-based rules that define different approval thresholds based on a risk level of a merchant associated with the purchase.

10. The method of claim 8, wherein the one or more transaction constraints included in the request for the restricted-use payment token comprise an identifier of the software agent, enabling the payment network system to validate that the transaction was initiated by the authorized software agent.

11. The method of claim 8, further comprising: receiving a single user approval for a high-level transaction intent comprising multiple planned sub-transactions; and autonomously approving a plurality of subsequent transaction requests from the software agent, wherein each subsequent transaction request is validated against the high-level transaction intent.

12. A system for managing agent-initiated digital transactions within a scalable trust network, the system comprising: a central Trust Authority computer system configured to issue cryptographic certificates to a plurality of agentic wallet systems and a plurality of payment service provider (PSP) systems, thereby establishing a unified trust domain; an agentic wallet system of the plurality of agentic wallet systems, the agentic wallet system being configured to:
authorize a software agent to act on behalf of a user;
receive a transaction request from the authorized software agent;
autonomously approve the transaction request based on a set of policies without requiring real-time user confirmation; and
in response to the approval, generate an encrypted payment bundle by encrypting payment data using a public key of the Trust Authority; and
a PSP system of the plurality of PSP systems, the PSP system being configured to:
receive the encrypted payment bundle; and
cause the decryption of the encrypted payment bundle to obtain the payment data for processing the transaction, thereby enabling a transaction between the agentic wallet system and the PSP system without a pre-established bilateral agreement.

13. The system of claim 12, wherein the policy engine of the agentic wallet system is configured to autonomously approve the transaction request by: first, applying a set of learned rules derived from a history of transactions previously approved by the user; and second, in response to determining that no learned rule from the set of learned rules applies, applying a set of pre-set, risk-based rules that define different approval thresholds based on a determined risk level of a merchant associated with the transaction.

14. The system of claim 12, wherein the agentic wallet system is further configured to, in response to the approval, request a restricted-use payment token from a payment network system, the request including one or more transaction constraints derived from the set of policies, wherein the transaction constraints include at least one of a merchant category, a maximum transaction value, and an identifier of the software agent.

15. The system of claim 12, wherein the PSP system is configured to cause the decryption of the encrypted payment bundle by transmitting the encrypted payment bundle to the Trust Authority computer system and receiving decrypted payment data from a decryption application programming interface (API) hosted by the Trust Authority computer system.

16. The system of claim 12, wherein: the Trust Authority computer system is further configured to issue a re-encryption key to the PSP system; and the PSP system is configured to cause the decryption of the encrypted payment bundle by:
using the re-encryption key to transform the encrypted payment bundle into a re-encrypted payment bundle; and
decrypting the re-encrypted payment bundle using a private key of the PSP system.

17. The system of claim 12, wherein: the PSP system is further configured to issue a merchant cryptographic certificate to a merchant system, the merchant cryptographic certificate including a public key of the merchant system; and the agentic wallet system is further configured to generate an encrypted personally identifiable information (PII) bundle by encrypting user PII with the public key of the merchant system, wherein the encrypted PII bundle is configured for transmission to the merchant system via the software agent.

18. The system of claim 12, wherein the agentic wallet system is further configured to: receive a single user approval for a high-level transaction intent, the intent comprising a plurality of planned sub-transactions; and autonomously approve a plurality of individual transaction requests received from the software agent, wherein each individual transaction request corresponds to one of the planned sub-transactions covered by the single user approval.
